(19) United States
(12) Patent Application Publication
(10) Pub. No.: US 2008/0046353 A1
(43) Pub. Date: Feb. 21, 2008

(54) SYSTEMS AND METHODS FOR TRADING REAL ESTATE SECURITIES

(76) Inventors: Alexander I Poltorak, Monsey, NY (US); Joseph Krasnjanski, Spring Valley, NY (US)

Correspondence Address: ANATOLY S. WEISER, 3525 DEL MAR HEIGHTS ROAD, #295, SAN DIEGO, CA, 92130, US

(21) Appl. No.: 11/740,873

(22) Filed: Apr. 26, 2007

Related U.S. Application Data
(60) Provisional application No. 60/794,974, filed on Apr. 26, 2006.

(51) Int. Cl. G06Q 40/00; G06Q 90/00

(52) U.S. Cl. 705/37

(57) ABSTRACT

Publicly traded securities and security derivatives are created based on underlying real properties, such as single family houses. An occupant of a house may be a majority holder of the public securities of a business entity owning the house. An exchange and a quotation system specializing in trading and quoting such securities may be implemented using computer systems. Various value metrics specific to real property may be used to screen the securities and to run a value fund of the securities.

### CROSS-REFERENCE TO RELATED PROVISIONAL APPLICATION AND DISCLOSURE DOCUMENT

This application claims priority benefit of provisional U.S. Patent Application Ser. No. 60/794,974, entitled METHOD OF TRADING REAL ESTATE EQUITY AND DERIVATIVE SECURITIES, filed on Apr. 26, 2006, which application is hereby incorporated by reference in its entirety, including all Figures, Tables, and Claims. This application is also related to Disclosure Document Number 585798, entitled “METHOD OF TRADING REAL ESTATE EQUITY AND DERIVATIVE SECURITIES,” filed on Sep. 9, 2005. The Disclosure Document is hereby incorporated by reference in its entirety.

### FIELD OF THE INVENTION

The present invention relates generally to real estate financing, and, more particularly, to creating and public trading fractional units in real properties, to creating and operating a specialized exchange for trading such units and their derivatives, to public trading of real estate-related securities and the securities' derivatives, and to quotation of such securities and derivatives.

### BACKGROUND

The US housing market, which represents some twenty trillion dollars in assets, is the only large asset class that, unlike stocks, bonds and commodities, has no public market for trading real estate securities and derivatives. Real properties do not land themselves easily to public trading due to the rights of occupancy associated with ownership and fragmentation of the market, which can make transaction costs prohibitive. Hedging and financial speculation is difficult in the absence of a market for derivatives.

Currently, one typical way for a house owner or homeowner to access the equity in the owner's house or other real property while occupying the real property is to obtain a mortgage, for example, a conventional mortgage, reverse mortgage, home equity line of credit, or other form of debt. Although access to realty-secured debt has become relatively easy over the last few years, the situation is changing with the now unfolding crisis in sub-prime mortgage lending. Tightening of mortgage leading standards has begun and appears to be increasing. Nevertheless, homeowners may wish to take advantage of the increased equity in their properties that accrued due to the booming real estate market of the last decade.

A homeowner can take out a home equity line of credit, which, when used, becomes a debt that must be repaid; or the homeowner can take out a mortgage, which, again, is a debt that must be repaid. A reverse mortgage is a special type of home equity loan for senior citizens. Reverse mortgages allow homeowners to convert some of the equity in their homes into cash through a loan that does not usually have to be repaid during the homeowner's lifetime. One disadvantage of reverse mortgages is that they are generally available only to persons of age 62 and above. If a younger homeowner wants to access home equity without assuming debt, the homeowner is generally unable to do so through a reverse mortgage.

Another typical way to access real estate equity is to cash out by selling the real estate. Cashing out by selling a residence generally necessitates moving out, which may be undesirable. Moreover, timing of the real estate market peak may not, and usually does not, coincide with a convenient timing for relocation, which may depend on other circumstances, such as change of employment, retirement, beginning of school year, and similar life events.

Thus, there are many homeowners with untapped equity in their homes, particularly in the markets where homes have appreciated significantly. At the same time, many people, and particularly those at the beginning of their working careers, have limited savings for a down-payment on a residence, and low monthly income that precludes qualifying for a large mortgage. It is therefore difficult for such people to buy a home.

Real estate investors are limited in their ability to invest in personal real estate by the necessity to buy a whole property, such as house or a lot. An investor with limited funds may wish to diversify his or her investment portfolio by investing in fractional (i.e., partial) ownership of several properties instead of buying one or two properties that the investor is able to afford if the investor has to buy the entire property. Presently, there appears to be no easy mechanism to buy or sell a fractional ownership in a house or apartment, particularly when the property is encumbered by a mortgage.

Participation in a general partnership, limited partnership, limited liability company (LLC), or a corporation that invests in real estate typically requires a substantial investment that is beyond the means of many ordinary investors. Moreover, limited partners in a limited partnership, non-managing members of an LLC, or corporate shareholders have no say in (or no direct and effective way to influence) the choice of the properties that these entities acquire. Furthermore, equity in such entities is not liquid. In the past, attempts have been made to trade real estate master limited partnerships (MLPs) on a stock exchange. An MLP is business that is organized as a limited partnership and trades proportionate shares of the partnership (units) on a public exchange. Burger King Investors Master L.P., which was underwritten by Merrill Lynch Capital Markets, was the first real estate master limited partnership listed on the New York Stock Exchange. MLPs generally acquire high cash flow, high depreciation assets (e.g., larger apartment buildings, shopping mails, etc.), which produce relatively low earnings under GAAP. (Because of the low accounting earnings produced by the assets, traditional public companies do not find the assets attractive.) The MLP investors focus on the cash flow of the assets not on the accounting earnings. For these reasons, MLP is not appropriate for investing in a fractional interest in a single-family home, which is occupied by the owner, and other similar properties that produces no or little cash flow. Presently, Real Estate Investment Trusts (REITs) appear to be the most popular publicly traded real estate holding investment vehicles. A REIT is a real estate investment organization, which finds investors, buys real property and gives each investor either a percentage interest in the property itself or an interest in a loan secured by a mortgage or deed of trust on the property. When the property is sold or the mortgage repaid, there is a division of profits. As a pass-through entity whose main function is to pass profits on to investors, business activities of a REIT are generally restricted to generation of property rental or mortgage income. To avoid taxation on the business entity level, most of the gross income must be derived from rents or mortgage interest and be distributed to shareholders. REITs do not allow homeowners to sell fractional interest in their homes. Nor do they allow investors to choose their own mix of real estate properties. Investing in a REIT is more akin to investing in a mutual fund, rather than buying stocks. Indeed, it has been observed that prices of REIT shares are correlated with stock markets to a greater extent than with the real estate markets.

A few investors of means are able to buy companies. However, millions of ordinary Americans do not have such means and opportunities, and consequently are limited to investing in and/or trading equities of companies listed on various stock exchanges. Wealthy real estate investors are able to buy and develop land, acquire apartment buildings, shopping malls and other real properties. However, there is no public market for real properties that would enable ordinary investors of limited means to buy and trade fractional interests in real properties similarly to the way they invest and trade publicly-traded shares of stock of companies listed on various exchanges.

There is presently an efficient market for real estate facilitated by a multiple listings system. Trading in cash-settled real estate indices is also known. But neither trading in entire properties nor trading in cash-settled indices enables a public market, similar to stock or commodity markets/exchanges for trading fractional equity interests in real estate, particularly in personal real estate, such as single-family homes.

Several online Internet sites and portals offer real property for sale or purchase. For example, eBay runs real estate auctions where land, houses, condominiums, timeshares, and commercial real estate may be auctioned to the highest bidders. Similarly, Yahoo! portal operates a real estate listing site, where a prospective buyer can search through real estate classifieds for houses and rentals. However, we are not aware of online auction or a website where a home-owner can sell or an investor can buy fractional non-possessory interest in a real property.

Several predicaments exist in creating a liquid market for trading real properties, real-estate securities, and their derivatives. A peculiarity of real property is that it is usually occupied. While ownership usually implies an exclusive right or possessory interest, the difficulty in subdividing a real property into shares available for trading lies in the fact that it is difficult or impossible to subdivide the possessory interest. Another difficulty lies in the fact that a sale of the property may require a clear title. If a property is subdivided and fractional share are sold, such fractional interests may need to be conveyed by a recordable deed. It may be impractical to clear the title of such property for sale. Yet another problem in creating a public market for real estate lies in the fact that this asset class is extremely fragmented and transaction costs of issuing financial instruments based on a single real property may be prohibitive in comparison with the value of the property itself.

Trading futures is well known and widely utilized as a hedging mechanism for commodity producers and buyers, as well as for speculative investment purposes. A real estate developer who buys property for subdivision and building and selling houses may wish to hedge against decline in residential home market. Similarly, commercial real estate developers who buy property for building and subsequently renting office space or other commercial real estate may wish to hedge against decline in commercial real estate market. Mortgage bankers could hedge against decline in property values that might increase risk of foreclosures. On the other hand, future home buyers or corporate executives anticipating expansion may wish to hedge against future rise in real estate prices.

In the real estate marketplace, call options have long been used to assemble large parcels of land from separate owners, e.g., a developer may pay for the right to buy several adjacent plots, but is not obligated to buy these plots and might not buy them unless he or she can buy all the plots in the entire parcel. However, there is not effective mechanism to trade options on single-family houses or fractional units thereof.

### SUMMARY

A need thus exists to enable people to access their home equity without taking additional debt or selling their homes.

An additional need exists to enable homeowners to sell fractional non-possessory equity in their real estate.

Yet another need exists to enable investors to buy fractional non-possessory equity in real estate.

Still another need exists to enable efficient public trading of fractional non-possessory equity interests in personal real estate.

A further need exists to establish a mechanism for trading derivative securities based personal on real estate.

Yet another need exists to reduce the cost of purchasing a residence by reducing down-payments and mortgage payments.

Still another need exists for enabling trading of real estate futures.

An additional need exists in creating fractional transferable units of undivided non-possessory interest in real properties.

Yet another need exist to enable conveyances of fractional interests in real property without a recordable deed.

Still another need exist in creating an online-based computerized marketplace for trading real estate financial instruments and their derivatives.

A further need exists to standardize and streamline listing of real property on an exchange in order to simplify the listing procedure and minimize the costs associated therewith.

One or more of these needs may be accomplished through a public offering of transferable shares or fractional units of undivided non-possessory interest in real property, as well as futures, options, and other derivatives associated with the real property, enabling investors to share in the appreciation of real estate, and reducing the amount of equity and debt necessary to buy or maintain the real property, and providing a hedging mechanism for real estate developers, buyers, tenants, and speculators.

One aspect of the invention herein disclosed is embodied in a method of public trading of fractional, non-possessory, undivided ownership interest in real property. Various embodiments of public trading of fractional ownership interest in real property in accordance with different aspects of the invention include a method of operating a real property exchange, a method of listing private homes on the real property exchange, a method of underwriting new listings of real property on the real property exchange, a method of making market in the listings trading on the real property exchange, a method of brokering shares in real property trading on the real property exchange, a method of repaying a mortgage on a real property by selling shares in the real property on the real property exchange, a method of writing calls and puts for shares in real property traded on the real property exchange, a method of trading futures contracts on real estate, and a method of trading other derivative securities based on shares in the real property traded on the real property exchange. Various aspects of the invention further include features on the following non-exhaustive list:

a method of issuing a standardized title report;

a method of issuing a standardized inspection report;

a method of issuing a standardized appraisal report;

a method of soliciting homeowners to list their homes on a real property exchange;

a method of pricing a real property for an initial public offering of shares in the property;

a method of operating an escrow account for collecting the proceeds of a public offering of a real property from which part of the collected funds is used to retire a mortgage on the real property;

a method of incorporating a real property for further listing of shares of the corporation on a stock exchange;

a method of trading real property futures contracts and options on a commodity exchange;

a method of operating a quotation system to quote real time prices for shares of real properties traded on a real property exchange;

a method of quoting prices of shares in real property on the Internet;

a method of trading shares in real property on the Internet;

a method of subdividing a real property into transferable units of equal, fractional, non-possessory, and undivided interest in the real property;

a method of trading units of equal, fractional, non-possessory, and undivided interest in the real property on the Internet-based exchange;

a method of auctioning off units of equal, fractional, non-possessory, and undivided interest in the real property on the Internet-based auction;

a method of trading futures contracts in real property on the Internet; and

a method of trading options on real property on the Internet.

In an embodiment, a method of creating a publicly traded security includes these steps: (1) forming a real property holding company with a plurality of partial interest units, (2) transferring ownership of a real property to the real property holding company, and (3) complying with applicable requirements for making the partial interest units publicly traded. At least one of the partial interest units belongs to an occupant of the real property.

In an embodiment, a system includes a network, at least one server connected to the network, a plurality of electronic devices connected by the network to interact with the at least one server, a database implemented on the at least one server, and a memory. The database stores information associated with publicly traded partial interest units in real properties. The information includes addresses of the real properties associated with the fractional interest units, area information regarding the real properties, and number of shares of fractional interest in real property holding companies owning the real properties. The memory stores machine executable instructions for implementing a computerized quotation system for quoting prices of the fractional interest units. When the instructions are executed by the at least one server (processor in the server), they configure the at least one server to perform these steps: quoting an ask price, quoting a bid price, accepting sell offers, accepting buy offers, matching at least one of the sell offers with at least one of the buy offers, and executing a sale satisfying the at least one of the sell offers and the at least one of the buy offers.

In an embodiment, a method of underwriting a public offering of units of a real property holding company includes the following steps: selecting a real property, performing a due diligence on the real property, reviewing a title report, reviewing an inspection report, reviewing an appraisal report, reviewing a registration statement, setting an initial price for the units, complying with requirements for public trading of the units, executing an underwriting commitment agreement, marketing the shares to prospective investors, and charging a commission on sales of the units.

Another embodiment is a method of transferring ownership of a real property owned by an owner to public through an initial public offering of shares, wherein the real property is encumbered by at least one mortgage. The method includes the following steps: setting up an escrow account, collecting proceeds from safe of the shares of the real property from the initial public offering into the escrow account, wherein the proceeds are not less than the at least one mortgage, repaying the at least one mortgage from the proceeds held in the escrow account, and disbursing at least a portion of remaining funds in the escrow account to the owner of the real property.

In an embodiment, a method of transferring fractional ownership in a privately-owned real property from an owner of the property to public includes these steps: forming a holding company, assigning a title and interest in the real property to the holding company, selling shares in the holding company to public, paying rent to the holding company, charging repairs and maintenance to the holding company, and distributing profits as dividends to shareholders of the holding company.

In an embodiment, a method of trading fractional ownership interests in a real property includes these steps: forming a corporation, assigning the real property to the corporation as the corporation's only investment asset, and listing the corporation on a stock exchange.

In an embodiment, a method of trading derivative securities associated with fractional ownership in a real property traded on a securities exchange includes the step of pricing the derivative securities based on price of underlying fractional ownership in the real property and time to expiration of the derivative securities.

In an embodiment, a method of selling interest in a real property includes these steps: selecting an appraiser from a predetermined set of appraisers, securing an appraisal of the property by the selected appraiser, selecting a property inspector from a predetermined set of property inspectors, securing an inspection of the real property specifying at least one physical condition of the property by the selected property inspector, dividing the real property into equal transferable fractional units of undivided non-possessory interest in the real property, and selling the equal transferable fractional units of undivided non-possessory interest in the real property to a plurality of buyers.

In an embodiment, a method of publicly trading fractional interests in a real property includes these steps: dividing the real property into a plurality of equal units of fractional undivided non-possessory interest in the property, issuing a plurality of shares, each share of the plurality of shares corresponding to one unit of fractional undivided non-possessory interest in the property, the each share entitling its owner to a corresponding unit of fractional undivided non-possessory interest in the property, listing the shares on a public exchange adapted to trade fractional interests in real properties, and selling the shares to a plurality of buyers on the exchange.

In an embodiment, a method of operating a real property exchange for trading units of fractional undivided non-possessory interest in real properties includes these steps: maintaining a list of approved appraisers, obtaining an appraisal by at least one of the approved appraisers in respect of each real property sought to be listed on the real property exchange, creating a set of criteria for listing a real property on the real property exchange, accepting for listing on the real property exchange a real property that meets the set of criteria, and listing the units of fractional undivided non-possessory interest in the real property on the real property exchange, thereby making the units available for purchase by public.

In an embodiment, a combination includes a real property, a title insurance for the real property, a homeowner's insurance for the real property, an inspection report for the real property, an appraisal of for the real property, and a plurality of transferable shares corresponding to equal fractional units of undivided non-possessory interests in the real property for public trading of the shares on an exchange.

In an embodiment, financial instruments for trading fractional undivided non-possessory interests in real properties are created by the process that includes these steps: selecting a real property, subdividing the real property into a plurality of equal shares of fractional undivided non-possessory interest in the real property, and issuing the shares for public trading on an exchange.

Another embodiment is a method of selling a real property owned by a corporation having a plurality of shareholders. The property was bought at a first price. The shares of the corporation are publicly traded. The method includes: selling the property to a second owner at a second price, computing capital gain as the difference between the second price and the first price, paying applicable capital gain tax on the stile of the property, computing a net profit as the capital gain less the capital gain tax less legal fees and disbursements associated with closing of sale of the real property to the second owner, computing a pro rata share of the net profit of the first owner of the property, distributing the remaining net profits to the plurality of shareholders, and cancelling the shares of the corporation.

In an embodiment, a computer-based method of operating an online real property exchange for trading shares of real properties includes the following steps: establishing a secure network for operating the exchange over the network, establishing a first website for listing a plurality of fractional shares of undivided non-possessory interest in at least one real property, establishing a second website for hosting information about the at least one real property, establishing an account for the owner of the at least one real property, establishing accounts for traders of the shares of the at least one real property, providing secure login to the owner of the at least one real property for login into the account for the owner of the at least one real property, providing secure logins to the traders for logging into the accounts for traders of the shares of the at least one real property, listing the fractional shares of real property on the real property exchange, and providing for trading of the shares in the at least one real property listed on the real property exchange.

In an embodiment, a system for operating a real property exchange for trading shares of real properties includes at least one server connected to a secure network for hosting the following: information about at least one real property listed on the real property exchange the information further comprising information about an area of the at least one real property, information about inspection of the at least one real property, an appraisal report of the at least one real property and at least one picture of the at least one real property, account information about the owner of the at least one real property listed on the real property exchange, and account information about buyers and sellers of the shares of the at least one real property listed on the real property exchange. The system further includes a central processing unit, non-volatile storage, and computer memory with loaded software program to match shares offered for sale by the sellers with offers to buy shares by the buyers.

In an embodiment, a method of creating units of a real property owned by an occupant includes subdividing the real property into a plurality of indivisible units, wherein each of the units is an equal fractional share of non-possessory undivided interest in the real property.

In an embodiment, a method of creating units of real estate investment instrument for investment in a real property includes obtaining an appraisal of the real property to determine initial market value of the real property, and offering for sale to at least one investor at least one unit of property appreciation in the real property from a plurality of units of property appreciation in the real property. Property appreciation is a difference between (1) a future sale price of the real property, and (2) sum of the initial market value of the real property as indicated by the appraisal and closing costs associated with the future sale. The property appreciation is set to zero if the difference is negative. Each of the units is obtained by dividing the property appreciation into equal parts.

In an embodiment, a method of creating a real-estate-backed derivative security includes: selecting a real property, obtaining an appraisal of the real property to determine the market value of the real property, setting a strike price, setting an expiration date, complying with legal requirements for public trading of options on the real property, and selling an option on the real property with an exercise price of the option being the strike price and an exercise date of the option being the expiration date.

In an embodiment, a method of creating real-estate options includes these steps: identifying a real property, subdividing the real property into a number of equal units of fractional non-possessory undivided interest in the real property, obtaining an appraisal of the real property to determine the market value of the real property, setting a strike price, setting an expiration date, complying with legal requirements for public trading of options on the real property, and selling an option on at least one of the units of fractional non-possessory undivided interest in the real property, wherein an exercise price of the option is the strike price and an exercise date of the option is on or before the expiration date.

In an embodiment, a method of direct public offering of a real property includes the following steps: selecting a real property occupied by an occupant, forming a corporation with the occupant as president of the corporation, transferring the real property to the corporation, registering shares of the corporation under Small Corporate Offering Registration to obtain registered shares, and offering the registered shares to investors. The amount of money raised from the investors through the offering does not exceed one million dollars in any one year, or another limit applicable to SCOR offerings.

In an embodiment, a method of providing for public investing in real property holding companies includes: setting criteria for initial listing on an exchange for public trading of a real property holding company, wherein the real property holding company has a plurality of fractional interest units, the real property holding company owns a real property occupied by an occupant, the occupant owns at least one of the fractional interest units, applicable legal requirements for public trading in the fractional interest units have been satisfied, and the real property is the sole investment asset of the real property holding company. The method includes qualifying the fractional interest units for listing on the exchange based on the criteria, listing the fractional interest units on the exchange, providing for trading of the fractional interest units on the exchange, monitoring compliance of the fractional interest units with criteria for continuing listing on the exchange, and delisting the fractional interest units from the exchange in response to the fractional interest units failing to meet the criteria for continuing listing.

In an embodiment, a method of facilitating trading includes: listing units on an exchange, providing for trading in the units on the exchange, and making market in units by maintaining a bid and an ask price on the units. In this embodiment, the units are fractional interest units of a real property holding company, the real property holding company owns a real property, the real property is the sole investment asset of the real property holding company, and applicable requirements for making the fractional interest units available for public trading have been complied with.

In an embodiment, apparatus includes: a local area network connected through a firewall to a wide area network, at least one server connected to the local area network, a portal for a plurality of electronic devices to connect through the wide area network to the at least one server, a database, and a memory. The database implemented on the at least one server and stores information associated with publicly traded shares of real properties. The shares are equal indivisible transferable fractional units of non-possessory undivided interest in the real properties. The stored information includes addresses of the real properties associated with the shares of real properties, area data associated with the real properties, property type data associated with the real properties, market value data associated with the real properties, and number of the shares of real properties. The memory stores machine executable instructions for implementing a computerized quotation system for quoting prices of the shares of real properties. When the instructions are executed by the at least one server, they configure the at least one server to perform, these steps: quoting an ask price, quoting a bid price, accepting sell offers, accepting buy offers, matching at least one of the sell offers with at least one of the buy offers, and executing a sale satisfying the at least one of the sell offers and the at least one of the buy offers.

In an embodiment, a method of transferring fractional ownership in a privately-owned real property from an owner of the real property to public includes forming a real estate holding company, assigning title to and interest in the real property to the real estate holding company, recording deed for the real property in the name of the real estate holding company, listing the real estate holding company on an exchange, offering shares in the real estate holding company for sale to public on the exchange, and receiving money from sale of the shares in the real estate holding company.

In an embodiment, a method of assisting in a transfer of interest in a real property includes soliciting a person owning the real property to form a real property holding company with a plurality of partial interest units, transfer ownership of the real property to the real property holding company, comply with applicable requirements for making the partial interest units publicly traded, retain at least one of the partial interest units, and sell at least one of the remaining partial interest units to public. The method also includes charging real estate brokerage commission to the person. The formation documents of the real property holding company grant occupancy rights to the person.

These and other features and aspects of the present invention will be better understood with reference to the following description, drawings, and appended claims.

### BRIEF DESCRIPTION OF THE FIGURES

FIG. 1 illustrates a relationship between and among real properties, a real property exchange, and investors, in accordance with an embodiment of the present invention;

FIG. 2 illustrates a relationship between real properties, an underwriter, real property exchange, and investors, in accordance with an embodiment of the present invention;

FIG. 3 illustrates a relationship between and among real properties, underwriter, real property, exchange, market makers, broker/dealers, and investors, in accordance with an embodiment of the present invention;

FIG. 4 illustrates a relationship between and among real properties, real property owners of the properties, shares of corporations owning the real properties, underwriter, real property exchange, market makers, broker/dealers, and investors, in accordance with an embodiment of the present invention;

FIG. 5 illustrates a relationship between and among real estate agent, real property owner, real property, inspection service, homeowner's insurer, title insurer, appraiser, real property exchange, and investors, in accordance with an embodiment of the present invention;

FIG. 6 illustrates selected components of a real property exchange, in accordance with an embodiment of the present invention;

FIG. 7 is a process flow diagram illustrating selected steps and decision blocks of a process for listing and maintaining the listing of shares of a corporation owning a real property on an exchange, in accordance with an embodiment of the present invention;

FIG. 8 is a process flow diagram illustrating selected steps and decision blocks of a process for listing shares of a corporation owning real property on an exchange and operating the corporation, in accordance with an embodiment of the present invention;

FIG. 9 is another process flow diagram illustrating selected steps and decision blocks of a process for listing shares of a corporation owning real property on an exchange and operating the corporation, in accordance with an embodiment of the present invention;

FIG. 10 is another process flow diagram illustrating selected steps and decision blocks of a process for listing shares of a corporation owning real property on an exchange and operating the corporation, in accordance with an embodiment of the present invention;

FIG. 11 is a process flow diagram illustrating selected steps and decision blocks of a process of operating a real property exchange, in accordance with an embodiment of the present invention;

FIG. 12 is a process flow diagram illustrating selected steps and decision blocks of a process of creating financial instruments for trading on a real property exchange, in accordance with an embodiment of the present invention;

FIG. 13 is a process flow diagram illustrating selected steps and decision blocks of a process of selling real property owned by a business entity with publicly traded units, in accordance with an embodiment of the present invention;

FIG. 14 is a process flow diagram illustrating selected steps and decision blocks of a process for operating a value fund specializing in units of occupied real properties, in accordance with an embodiment of the present invention; and

FIG. 15 is a simplified block diagram representation of a computer-based system configured in accordance with selected aspects of the present invention.

### DETAILED DESCRIPTION

In this document, the words “embodiment” and “variant” refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar expressions and phrases are used to indicate one of a number of different possible embodiments. The number of possible embodiments is not necessarily limited to two or any other quantity. Characterization of an item as “exemplary” means that the item is used as an example. Such characterization of an embodiment does not necessarily mean that the embodiment is a preferred embodiment; the embodiment may but need not be a currently preferred embodiment. All embodiments are described for illustration purposes and are not strictly limiting.

The words “couple,” “connect,” and similar expressions with their inflectional morphemes do not necessarily import an immediate or direct connection, but include connections through mediate elements within their meaning.

References to “shares” throughout the description are intended to encompass fractional interest units of ownership in different business entities, such as corporations, limited liability companies (LLCs), investment trusts, and various partnerships. “Partial interest units” include corporation shares, partnership interests, and limited liability company memberships. Similarly, references to “corporation,” “incorporation,” “incorporated,” and various inflectional morphemes of these terms in the description are intended to encompass such different business entities and the process of forming such business entities.

A single “personal real property” owned by a business entity means a real property including the residence of an “occupant” as that term is used herein. The occupant has occupancy rights in the residence, as discussed further below. “Incorporated real property” is a real property owned by a business entity (e.g., a corporation, an LLC, an investment trust or a partnership) wherein the real property is the principal (i.e., essential, main, primary, key, major, most significant, or largest) asset of the business entity. This does not preclude such business entity from owning other minor assets such as computers, office supplies, tools needed to maintain the real property and the easiness entity. The occupant may also own a substantial portion or all of the units of the business entity.

The words “fractional” and “partial” are used interchangeably when referring to ownership or equity interests. “Partial interest” means less than total interest in or ownership of the real property of a business entity that owns the real property. “Fractional units of interest” or “units of fractional interest” used herein interchangeably mean equal units of partial ownership. “Shares of real property” in some embodiments may mean transferable fractional units of real property or in other embodiments may denote shares of business entity that owns the real property.

References to “sole investment asset” are intended to signify that a real property constitutes more than ninety percent (by value) of investment assets of a business entity.

“Regulatory requirements” and “legal requirements” signify respective requirements applicable in the country with jurisdiction over trading in issue; in specific embodiments and variants, the country is United States.

“Regulatory requirements” and “legal requirements” signify respective relevant requirements applicable in the country with jurisdiction over sale of real estate and trading of securities and commodities at issue; in specific embodiments and variants, the country is United States, wherein such requirements may include the Federal statutory requirements that are set forth by the Investment Act of 1933 as amended in 1934 and regulated by the Securities and Exchange Commission; “Blue Sky” registration requirement, state securities laws, and common law requirement. “Regulatory requirements” are subsumed in “legal requirements.”

“Non-possessory” ownership of a real property means ownership that does not entitle to exercise control or exclusionary right to the property or to possession of the property; this may be a contractually-based interest in a predetermined share of the equity in the real property realizable at a time of sale or imputed sale of the property or as pro rata dividends paid from the rental of the property; this may also be ownership of a share or other unit of a business entity that owns the real property, without entitlement to possession of the real property.

References to “indivisible” units of interest and similar expressions include within their meaning units of interests in real property that are contractually prevented from being further subdivided between two or more holders of beneficial property interest.

References to “undivided” interest and similar expressions include within their meaning non-specific share of the equity in the real property as a whole realizable at a time of sale or imputed sale of the property or as pro rata dividends paid from the rental of the property, as opposed to an ownership right to a specific room or a specific area in the property.

References to “reviewing” of legal and appraisal documents relating to real property and securities include reading the documents to identify problems with the documents and the underlying property or security, and to assure completeness of the documents from perspective of meeting necessary legal and regulatory requirements.

Generally, “cash-settled” refers to contracts that settle for cash rather than the delivery of the underlying commodity, contract, or similar item. Contracts based on real estate indices may settled based on the value of the underlying index rather than through delivery of real estate. A real estate index may be based on a statistical measure, such as average price.

“Transferable” in the context of shares/units means that the shares of real property may be freely transferred between owners without the need of conveyance of interest by a recordable deed. Such shares may be created contractually and represent contractual rights.

Other and further definitions and clarifications of definitions may be found throughout this document.

Reference will now be made in detail to several embodiments of the invention dial are illustrated in the accompanying drawings. Same reference numerals are used in the drawings and the description to refer to the same apparatus elements and method steps. The drawings are in simplified form, not to scale, and omit apparatus elements and method steps that can be added to the described systems and methods, while including certain optional elements and steps.

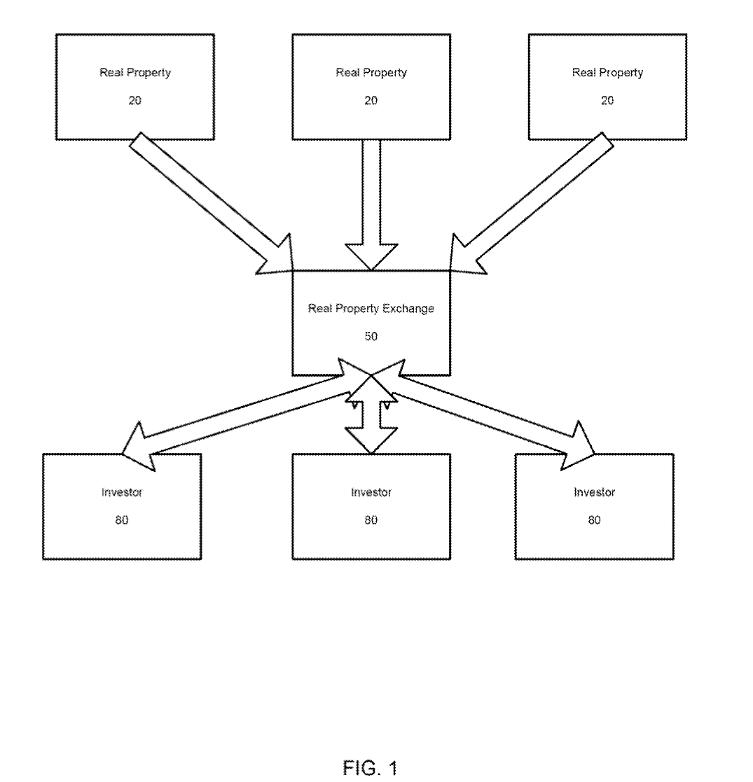

FIG. 1 illustrates a relationship between and among real properties 20, a real property exchange 50, and investors 80, in an embodiment. The real properties 20 are listed on the exchange 50, enabling the investors 80 to buy and sell shares (or other ownership units) in the properties 20 on the exchange 50, in accordance with aspects of the present invention. It should be noted that each of the real properties 20 may be separately incorporated (or otherwise transferred to a business entity, not limited to corporate forms) and its shares may be separately traded. In some embodiments, however, two or more of the properties 20 may be incorporated together, and shares in the corporation combining the multiple properties may be traded on the exchange 50 and owned by the investors 80.

It should be noted that in some embodiments, real properties are not incorporated but instead are subdivided into equal transferable fractional units of undivided non-possessory interest in the real properties, which units are offered on a real property exchange adapted for trading such units for sale to and for trading between investors in accordance with aspects of the present invention.

For a single-property corporation, the occupant of the underlying real property 20 may have limited rights to tenancy in the property under the terms of the governing corporate documents, in addition to a substantial ownership in the shares of the corporation. For example, the occupant may have a right to occupy the real property 20 for a period of time, such as one, three, five, seven, ten, fifteen, twenty, twenty five, or thirty years. The right may be non-transferable, or the right may be transferable in a limited manner. For example, the occupancy right may be transferable to designated persons upon occurrence of some predetermined condition, such as death or disability of the occupant. “Occupant” may be a single person, a married couple with or without children, or an otherwise legally recognizable domestic partnership. Upon death of an occupant, the occupancy right may be transferred to the occupant's spouse or children who reside in the real property. It should be noted that the real property need not be the occupant's primary residence. In some embodiments the occupant is not required to occupy the real property, in other embodiments, however, the occupant is required to occupy to real property. In some embodiments, the occupant may be required to pay rent to the business entity owning the real property. In some embodiments in which a real property is subdivided into fractional units of undivided non-possessory interest and some of these units are sold to investors, the occupant may be required to pay rent to an escrow account from which the rent is distributed to shareholders. In some embodiments, a service company may be required to collect the rent and to distribute due rent to the owners of the fractional units. In other embodiments, the occupant is not required to pay rent. Occupant may also be responsible for maintaining the property, paying all applicable local taxes, such as property taxes, school taxes, and other taxes. In those embodiments in which the occupant may be required to pay rent to the corporation, the occupant may be permitted to deduct some or all of the taxes, maintenance fees, and/or other expenses associated with maintaining the property.

The occupancy right may be terminable for a variety of reasons, such as destruction of the property; failure adequately to maintain the property; failure adequately to insure the property against physical loss (fire, flood, earthquake damage); occupant's attempt to rent out the property to a third party; occupant's default of other occupancy conditions; loss of creditworthiness by the occupant; an attempt by a third party to foreclose on the shares held by the occupant; or an attempt by a bank holding a mortgage on the property to foreclose on the property; excessive number of persons residing on the property under the occupant's authority; or violations of local ordinances, applicable home owners association rules, state laws, or federal laws. The occupancy right may also be terminated if the occupant (and possibly spouse and/or other family members) moves out of the property or is absent from the property for a predetermined period of time, such as six mouths. In some embodiments, the occupancy right may terminate in the event of insolvency of or bankruptcy filing by the occupant.

In some embodiments, a corporation owning the real property may be required to have a board of directors. The minimum number of directors may be fixed in some embodiments as three, five, or seven. Some of these directors may be required to be independent, i.e., not include property occupants and persons related to the property occupants. The board of directors may have fiduciary responsibility to the shareholders of the corporation. In some embodiments, the property occupant may be deemed to be the chief executive officer (CEO) of the corporation having duty of care.

The property occupant may hold a substantial number of shares in the corporation owning the property. For example, the occupant may be required to hold at least seventy five percent, sixty six percent, fifty percent, thirty three percent, twenty five percent, or ten percent of the shares. The investors holding the remaining shares may rely on the laws and regulations protecting minority shareholders, or the corporate charter and bylaws and other formation and governing documents may grant additional rights to the investors-shareholders in order to prevent potential abuse by the occupant of the majority (or major) voting block of the stock in the corporation. In some embodiments, the different classes of shares are issued to the outside investors and the occupant. For example, the shares issued to the occupant may be non-voting, or have less voting rights than the shares issued to the outside investors, who may also have veto power. In some embodiments, the occupant may have preferred shares having special voting rights or veto power. In some embodiments, non-occupant shareholders may have the right to elect at least one director to the board of directors of the corporation.

It should be noted, however, that the invention does not require the person in current possession of the real property to own any shares or other units in the real property or the business entity owning the real property.

In some embodiments, the occupancy right may be terminated when the percentage of shares held by the occupant falls below a predetermined level, such as one half, forty percent, one-third, one-quarter, or one-tenth.

The occupant may be required to insure and maintain the property in good repair. The occupant may also be required to obtain inspection reports on a periodic basis. Such inspection reports may be required, for example, on a monthly, quarterly, semi-annual, or annual basis. In some embodiments, the occupant of the property may be required to maintain an umbrella insurance policy to insulate outside investors from liability. As has been mentioned, failure to insure or maintain the property may be grounds for termination of the occupancy rights, or delisting of the business entity that owns the property from the real property exchange or another exchange on which the shares of the business entity are trading.

In some cases, the occupant may be required to pay rent, either in addition to the expenses of insuring and maintaining the property, or in lieu of such expenses. The rent may be held constant, or it may be indexed. The applicable index may be the inflation index for urban or suburban residents, or index of real property prices or real property rents. The applicable real property price or rent index may be nationwide, state-wide, or local. Some limits on indexing may be imposed, for example, preventing drop in the rent even when the applicable index falls, or capping annual (or other periodic) rent increases to ten percent or to another predetermined percentage or amount.

It should be noted that in some embodiments the business entity owning the property carries some or all of the property's expenses, such as repairs, insurance, and taxes.

In some embodiments, the property occupant or the corporation owning the real property may be required to file periodic reports, such as quarterly reports or annual reports. Such reports may include a simple financial statement, a title report, an inspection report, evidence of insurance policy in force, or an appraisal report. In some embodiments, financial statement may require to be audited. Such quarterly and/or annual reports may be submitted to the Securities and Exchange Commission (SEC) or other regulatory body. Alternatively, such reports may be submitted to the real property exchange or another exchange on which shares of the business entity owning the real property are traded.

In other embodiments, simplified standardized forms may be required to be filled and filed with the real property exchange. Such standardized forms may include a simple profit and loss statement (P&L) showing expenses paid by the occupant of the real property and income from the rent paid by the occupant. Such forms may also include standardized title, appraisal, inspection, or insurance reports. The occupant of the real property may be required to file a P&L report, while the inspection report may be filed by the inspector and the appraisal report may be fried by the appraiser. A real property exchange may maintain lists of certified inspectors and appraisers who may be authorized to file such reports with the exchange. Such forms may be filed electronically. A filer (e.g., the occupant, inspector, appraiser or insurance agent) may be required to login electronically via the Internet or an extranet into a secure website maintained by the home equity exchange in order to fill the standard forms linked to a particular property whose shares are traded on the exchange.

When the occupancy right expires or is otherwise terminated, the corporate governing documents or the registration statement (“prospectus”) may provide for sale of the property with payment of a dividend from the sale proceeds. The occupant or the occupant's successor (e.g., heir, spouse, child, will/trust beneficiary) may be granted the right of first refusal (i.e., the right of first refusal to buy the property upon the termination of occupancy rights) when the property is offered for sale. In some embodiments, the property may be put on the rental market at the then-current fair market rate, redeveloped, or mortgaged.

It should be noted, however, that the sale of the real property within a specified period need not actually take place. At the expiration of occupancy rights, the property occupant who has the first refusal right, instead of offering the property for sale and then exercising his or her first refusal right, may have the option to have the property appraised to buy back from the shareholders of the business owning the real property the outstanding shares at the fair market price, thereby regaining full ownership of the property. The occupant then may (but need not) dissolve the business entity and take title to the property.

The invention does not preclude other methods of distributing benefits of the property's value and appreciation upon termination of the occupancy rights.

In some embodiments, the real property occupant may be required or permitted to retain a property management service whose duties may include collecting rent from property occupants, maintaining the property, paying insurance premiums and/or property taxes, hiring property appraisers and inspectors, compiling and/or filing reports with the real property exchange or an appropriate regulatory agency. Such management service companies may be compensated by cash, shares in real property that they service, warrants and/or incentive stock options on such shares of real properties that they manage. The real property exchange contemplated hereunder may maintain a list of certified property management companies that are authorized to perform such services. A service company may be required to be insured and/or bonded.

In some embodiments the property may be a multi-unit property, for example, a two-unit property, three-unit property, or a four-unit property. In many locations, owner-occupied one- through four-unit properties are exempt from many laws and regulations, such as rent control. In some variants, only property thus exempt from rent control may be listed on a real property exchange or be owned by a business entity listed on an exchange.

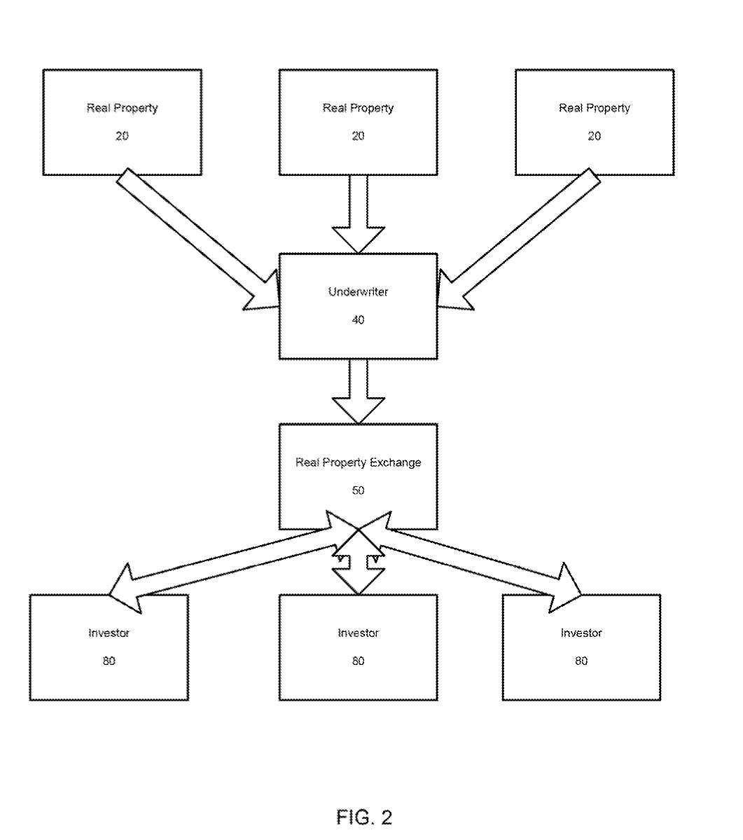

FIG. 2 illustrates a relationship between the real properties 20, an underwriter 40, the real property exchange 50, and the investors 80. Here, the underwriter 40 underwrites the initial public offering of the shares of the corporations owning the properties 20. The underwriter 40 may also act as a market maker in stocks of the corporations on the exchange 50. The exchange 50 may be a specialized exchange especially maintained for trading stocks of personal real properties such as the properties 20.

It should be mentioned that the present invention does not require an underwriter for the initial public offering (IPO) of shares in the business entity owning the real property. Such IPO may be self-underwritten or a direct public offering. Furthermore, the shares may be issued in so-called Small Corporate Offering Registration (SCOR) offering, which are allowed to raise up to $1,000,000 per year in a simplified regulatory environment. Such offerings do not require a registration statement to be filed with the Securities and Exchange Commission. Instead, a simple questionnaire need to be completed by the issuer. “Blue Sky” registration may also be obviated in SCOR offering. An Internet-based real property exchange may have on its website a version of such questionnaire specifically adapted for real property holding companies, wherein the issuer of the shares in real property may conveniently fill out required questionnaire and other forms necessary to comply with regulatory requirements.

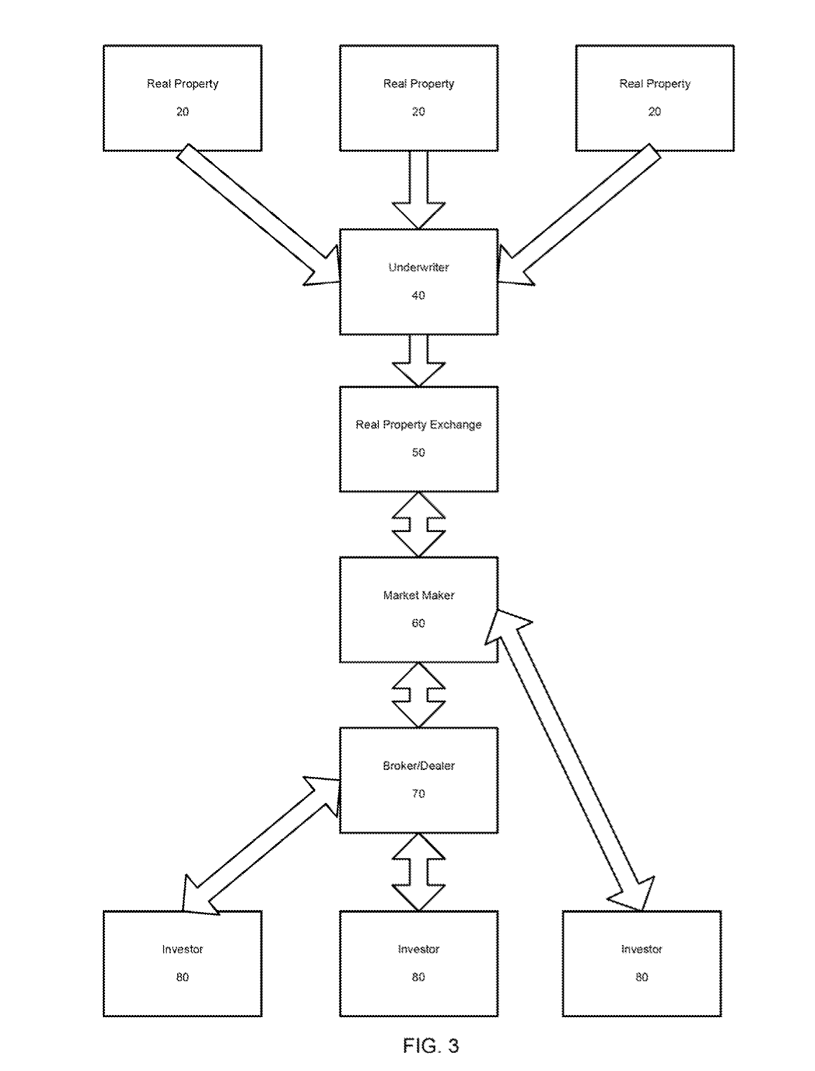

FIG. 3 illustrates a relationship between and among the real properties 20, the underwriter 40, the real property exchange 50, market makers 60, broker/dealers 70, and the investors 80. Here, the underwriter 40 underwrites initial public offerings of shares of the corporations owning the properties 20. The market makers 60 make market in the stocks of the corporations by maintaining the spread between ask and bid prices on the shares, and by buying or selling the stocks when needed to maintain market liquidity. The broker/dealers 70 accept and execute trades in the shares, and the investors 80 buy and sell the shares, in accordance with aspects of the present invention.

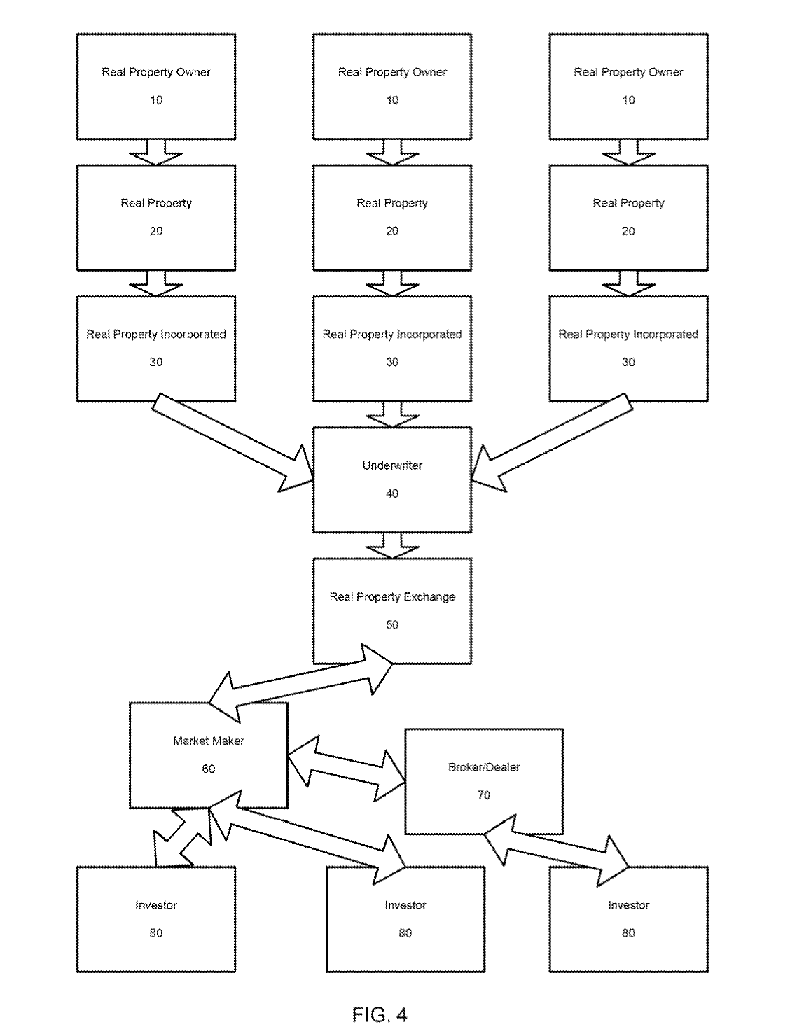

FIG. 4 illustrates a relationship between and among the real properties 20, real property owners 10 of the properties 20, shares of the corporations 30 owning the real properties 20 (after incorporation), the underwriter 40, the real property exchange 50, the market makers 60, the broker/dealers 70, and the investors 80. Here, the real property owners 10 incorporate their respective real properties 20 and issue shares of the incorporated real properties 20 in initial public offerings underwritten by the underwriter 40. The market makers 60 make market in the stocks on the exchange 50 as described above, and the broker/dealers 70 accept and execute trades in the shares of the corporations 30. The investors 80 buy and sell the shares of the corporations 30 on the exchange 50 through the broker/dealers 70. Some of the broker/dealers 70 may also act as the market makers 60, in accordance with aspects of the present invention.

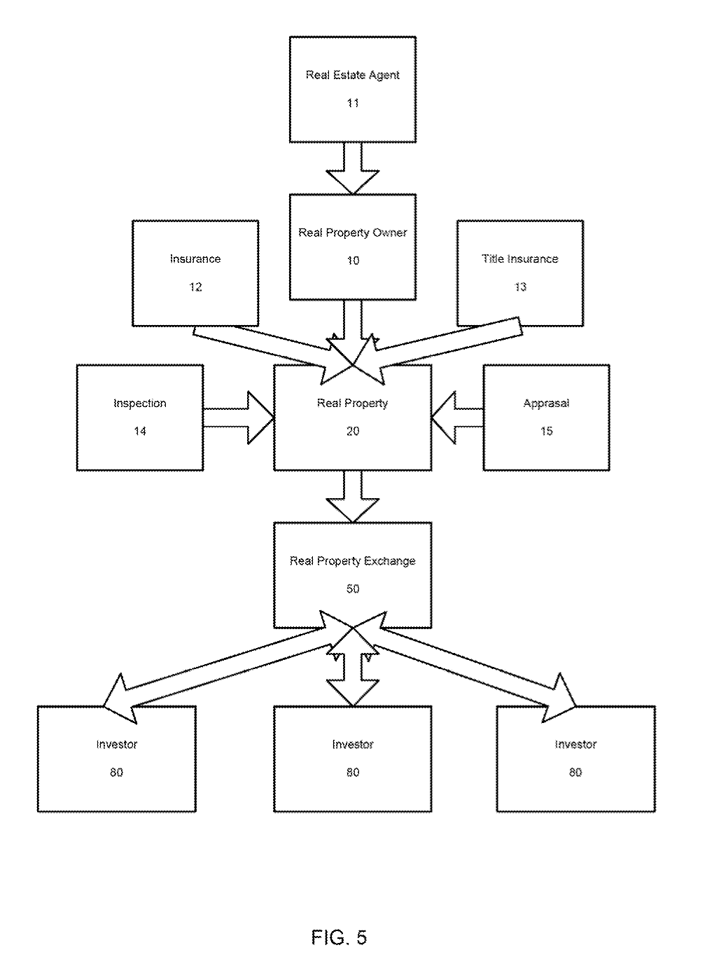

FIG. 5 illustrates a relationship between and among a real estate agent 11, a real property owner 10, a real property 20, an inspection service 14, a homeowner's insurer 12, a title insurer 13, an appraiser 15, the real property exchange 50, and the investors 80. Here, the real estate agent 11 solicits the real property owner 10 to incorporate and list his or her real property 20 on the real property exchange 50, arranges for the homeowner's insurer 12 to provide a home insurance policy on the real property 20, arranges for the title insurer 13 to provide title insurance for the real property 20, arranges for the inspection service 14 to provide an inspection report for the real property 20, and arranges for the appraiser 15 to provide an appraisal of the real property 20 for forming the corporation 30 (not shown in FIG. 5) and listing the shares of the corporation 30 on the real property exchange 50, in accordance with aspects of the present invention. Alternatively, the real estate agent 11 may help the owner 10 to locate a suitable property for purchase by the corporation 30. Shares in the corporation 30 may then be distributed to the investors 80, either before or after closing on the property 20. In the sale transaction, the real estate agent 11 may represent the owner 10, the seller of the real property 20, or both parties. The real estate agent 11 may also or instead represent the underwriter of the corporation 30. The shares of the corporation 30 may then trade as described throughout this document.

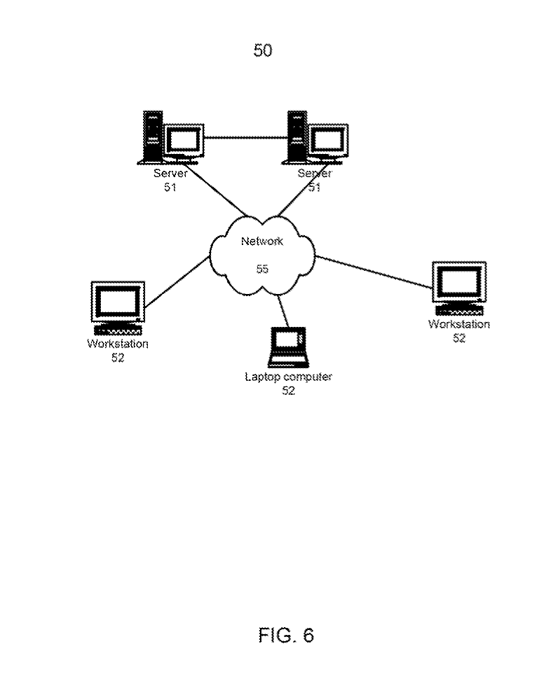

FIG. 6 illustrates a real property exchange 50, which includes servers 51 running automatic quotation software and trading software that may utilize a Price/Time (FIFO) trading algorithm in which the highest bid or lowest offer has priority over orders in the same contract month, and the first order at a specific price has priority over all other orders at the same price, and workstations 52 connected to the servers 51 through a network 55. The automatic quotation software running on the servers 51 provides price quotes for the shares of the traded real property corporations 30. The price quotes may be real time quotes accessible through the workstations 52, allowing the investors to place buy and sell orders for the shares. The orders may be executed on the servers 51, in accordance with aspects of the present invention.

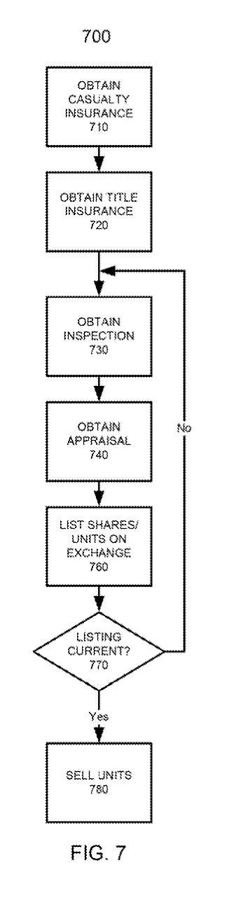

FIG. 7 is a process flow diagram illustrating selected steps and decision blocks of a process 700 for listing and maintaining the listing of an incorporated real property (i.e., shares of a corporation owning such a property) on an exchange. The process 700 includes obtaining physical (i.e., casualty) property insurance covering the property (step 710), obtaining title insurance covering the property (step 720), obtaining an inspection report for the property (step 730), obtaining an appraisal of the real property (step 740), and listing the property on the real property exchange (step 760). Listing on the exchange may include complying with the statutory and regulatory (SEC, state) requirements to make the shares/units available for purchase by public investors in the same manner as are stocks in publicly held corporations, for example, by providing the legally required disclosures. Additionally, listing on the exchange may include complying with the exchange's requirements for listing stocks, for example, capitalization requirements. The process 700 further includes a decision block 770 in which a determination is made whether the listing is current or has expired. A listing may expire, for example, upon lapse of a predetermined period of time, or when any listing requirement is no longer satisfied. If the listing is current, the shares are sold to public investors in step 780; otherwise, process flow returns to the step 730.

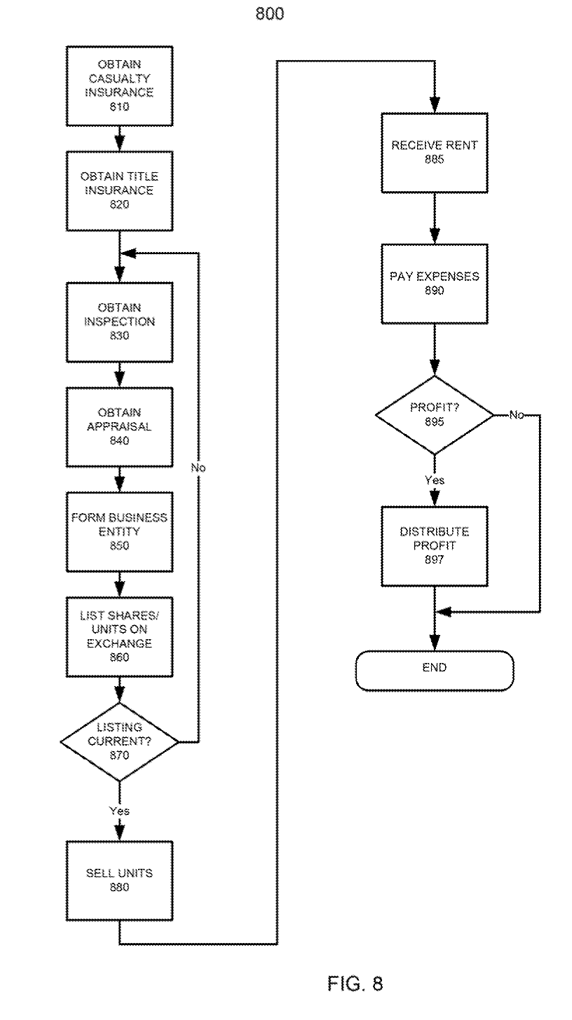

FIG. 8 is a process flow diagram illustrating selected steps and decision blocks of a process 800 for listing shares of a corporation owning real property on an exchange and then operating the corporation, in accordance with aspects of the invention. The process includes obtaining casualty insurance covering the property (step 810), obtaining title insurance covering the property (step 820), obtaining an inspection report for the property (step 830), obtaining an appraisal of the real property (step 840), forming the corporation (or another business entity) owning the property (step 850), and listing the property on the real property exchange where such shares trade (step 860). The process 800 further includes a decision block 870 in which a determination is made whether the listing is current or has expired. If the listing is current, the shares are sold to public investors in step 880; otherwise, process flow returns to the step 830. In step 885, rent is received, for example, from the occupant. Rent may also he received from additional tenants if the property is a multi-unit property. (Such tenants are considered non-occupant tenants, though they do in fact occupy the real property; we choose this designation to distinguish such tenants from the “occupant” who has occupancy rights pursuant to the corporate charter or other business formation documents, and who owns a portion of the stock of the corporation.) In step 890, repair and other expenses that are not chargeable to the occupant are paid from the rent received. If repair and other expenses not chargeable to the occupant exceed the rent received, a deficit results. The deficit may be payable from a reserve fund, or the shareholders may be assessed pro rata or otherwise. If profits are left over after the expenses are paid in the step 890, as determined in decision block 895, they may be distributed in step 897 to the shareholders, either in whole or in part. Distributing a high predetermined percentage of the rents may be advantageous in that this may allow the corporation to be treated as a pass through entity. It should be noted that the steps 885, 890, 895, and 897 may be performed before all or even some of the shares are sold in the step 880.

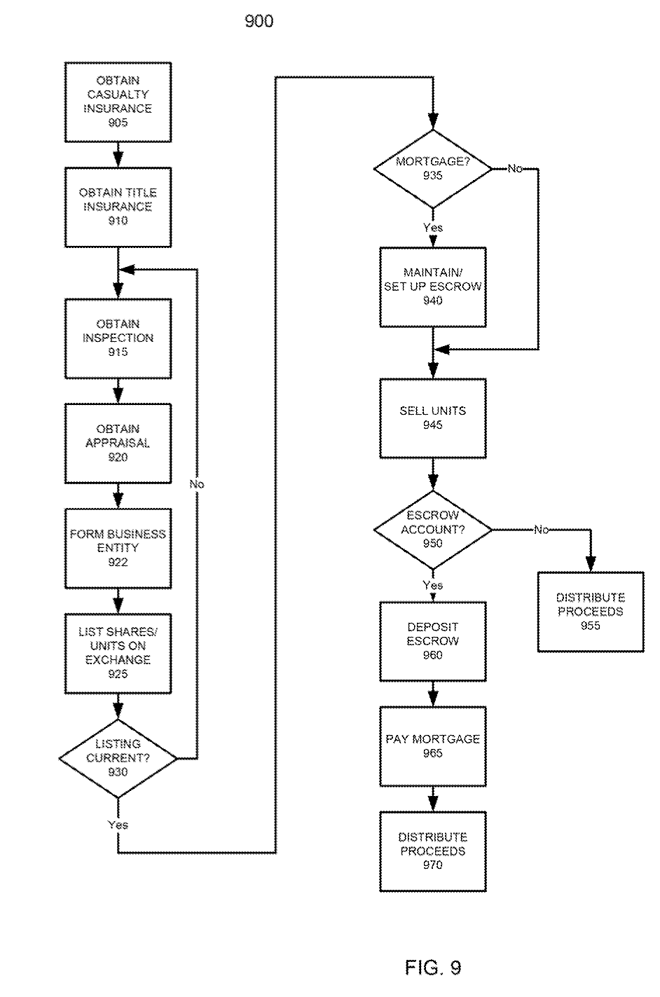

FIG. 9 is another process flow diagram illustrating selected steps and decision blocks of a process 900 for listing shares of a corporation owning real property on an exchange and then operating the corporation, in accordance with aspects of the invention. The process 900 includes obtaining casualty insurance covering the property (step 905), obtaining title insurance covering the property (step 910), obtaining an inspection report for the property (step 915), obtaining an appraisal of the property (step 920), forming the corporation or another business entity owning the property (step 922), and listing the shares of the business entity on the real property exchange where such shares are traded (step 925). The process 900 further includes a decision block 930 in which a determination is made whether the listing is current. If the listing is not current, process flow returns to the step 915. Otherwise, decision block 935 determines whether there is a mortgage on the property. If a mortgage on the property exists, an escrow account is set up and/or maintained, in step 940, and the process flow then proceeds to step 945. If there is no mortgage, process flow proceeds to the step 945 from the decision block 935, skipping the step 940. In the step 945, shares of the corporation owning the property are sold to investors and sale proceeds are collected. Decision block 950 determines whether there is an escrow account, such as the escrow account set up in the step 940, or a reserve fund account. If there is no such account, proceeds are distributed to the share owners, in step 955. If there is an escrow or reserve fund account, the proceeds are deposited into such account, in step 960. (It should be noted that there may be several such accounts.) Mortgage payment is made from the escrow account in step 965, and the remainder proceeds are distributed to the share owners in step 970. The process of making the mortgage payment may be repeated periodically, monthly, for example, corresponding to the period of the periodic mortgage payments. The mortgage may also be paid off entirely, for example, with the last scheduled periodic payment, or with a scheduled or unscheduled balloon payment.

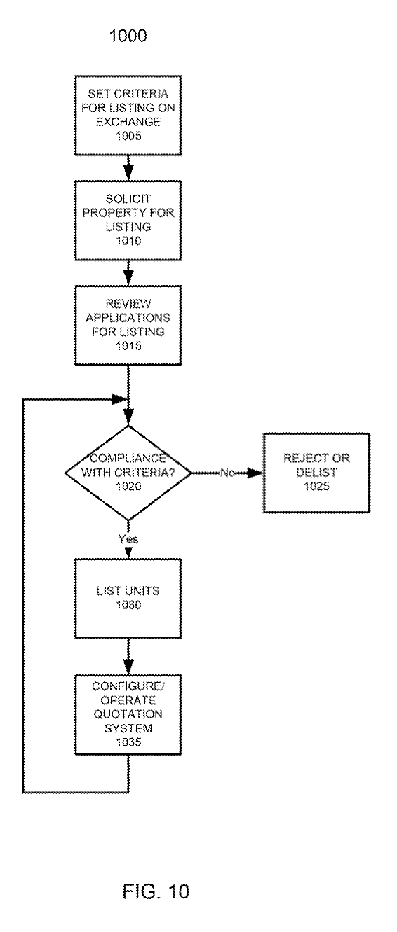

FIG. 10 is a process flow diagram illustrating selected steps and decision blocks of a process 1000 for listing shares of a corporation owning real property on an exchange and then operating the corporation, in accordance with aspects of the invention. The process 1000 includes setting criteria for listing a real property (i.e., shares of the corporation or units of another business entity that owns the real property) on an exchange (step 1005), soliciting real properties for listing on the exchange (step 1010), reviewing applications for listing on the exchange (step 1015), and determining initial or continuing compliance of the listing with the criteria (decision block 1020). As has already been mentioned, listing criteria may include statutory, regulatory, and exchange-specific requirements. If the operation of the decision block 1020 results in a determination that the property (i.e., the business entity owning the property) does not meet the criteria, process flow proceeds to step 1025 to reject the application for listing the property (if the property was not listed) or to de-list the property (if the property was previously listed). Otherwise, the process flow proceeds to step 1030, in which the property is initially listed or continues to be listed on the exchange. At step 1035, a quotation system is configured to quote prices (e.g., bid/ask prices) for the units of the business entity that owns the property. The process flow returns to the decision block 1020 to verify continuing compliance with the listing criteria. This may be done at predetermined times, continually, continuously, sporadically, or otherwise.

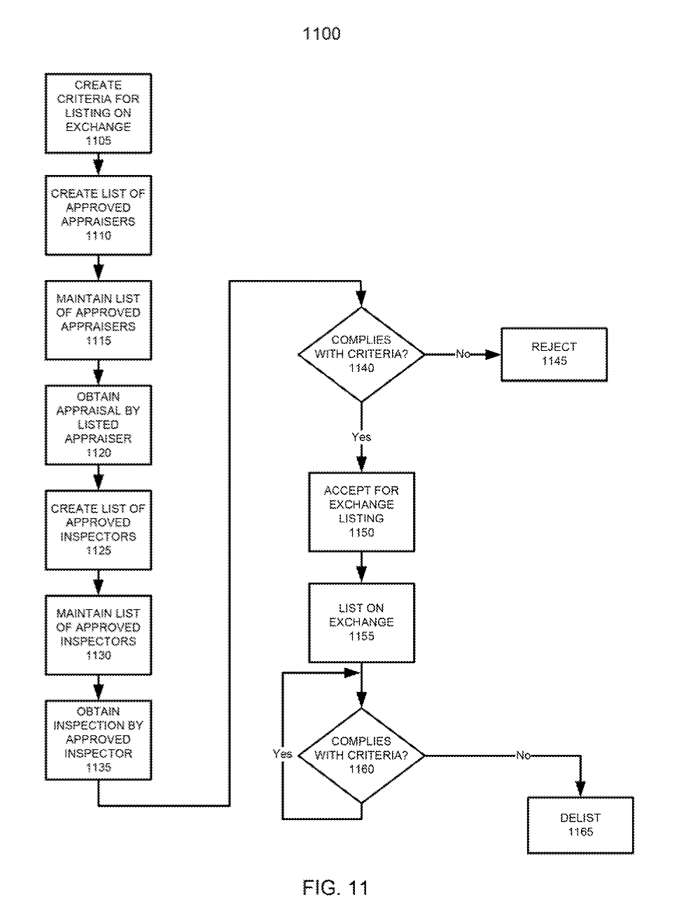

FIG. 11 is a process flow diagram illustrating selected steps and decision blocks of a process 1100 of operating a real property exchange, in accordance with aspects of the invention. The process 1100 includes setting criteria for listing units of a real property on the exchange (step 1105), creating a list of approved/authorized appraisers (step 1110), maintaining the list of approved appraisers (1115), obtaining an appraisal from an approved/authorized appraiser on the appraiser list (step 1120), creating a list of approved/authorized inspectors (step 1125), maintaining the list of approved inspectors (step 1130), obtaining an inspection, from an approved inspector on the inspector list (step 1135), and determining compliance of the listing with a preset criteria (decision block 1140). If the real property or the business entity owning it does not meet the criteria, the property/entity is rejected (step 1145). Otherwise, process flow continues to step 1150, accepting for listing the real property that meets the preset criteria for listing, and listing fractional interest (units, such as shares) in the real property on the exchange (step 1155). To continue monitoring compliance with the criteria, process flow then proceeds to decision block 1160. If the criteria is not met, the units of the business entity owning the property are de-listed, in step 1165. Otherwise, the listing of the units continues.

It should be noted that the criteria applied in the decision block 1160 may be the same as the criteria applied in the decision block 1140; alternatively, the two decision blocks may apply different criteria.

Regarding creation of lists of approved appraisers and inspectors, a person or company providing such services may be required, for example, (1) to be bonded, (2) to have been in business for a predetermined time, (3) to belong to selected business or professional organizations, and (3) not to have an excessive number of complaints (in relation to its total business) lodged against it in a predetermined time period.

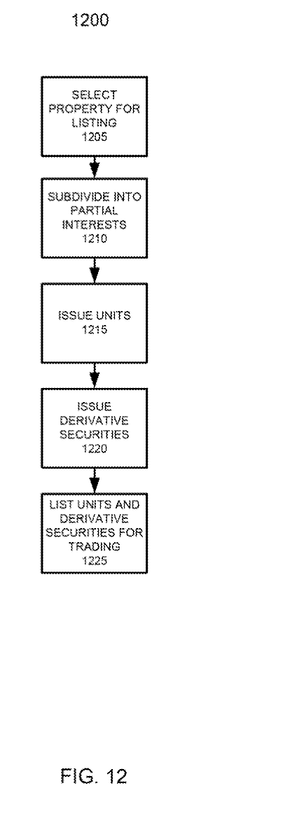

FIG. 12 is a process flow diagram illustrating selected steps and decision blocks of a process 1200 of creating financial instruments for trading on a real property exchange, in accordance with aspects of the invention. The process 1200 includes selecting a real property for listing (step 1205), for example, a property not older than a preset cutoff age and having a minimum area and a minimum number of rooms. The process 1200 also includes subdividing the property into equal fractional interests (step 1210), for example, by incorporation or creation of a partnership, and issuing shares or other units corresponding to the fractional interests (step 1215). The process 1200 further includes issuing derivative securities (step 1220) based on the shares or units, and listing the shares/units and derivative instruments based on the shares/units on a real property exchange for trading (step 1225). Derivative securities may include options (calls, puts) and futures.

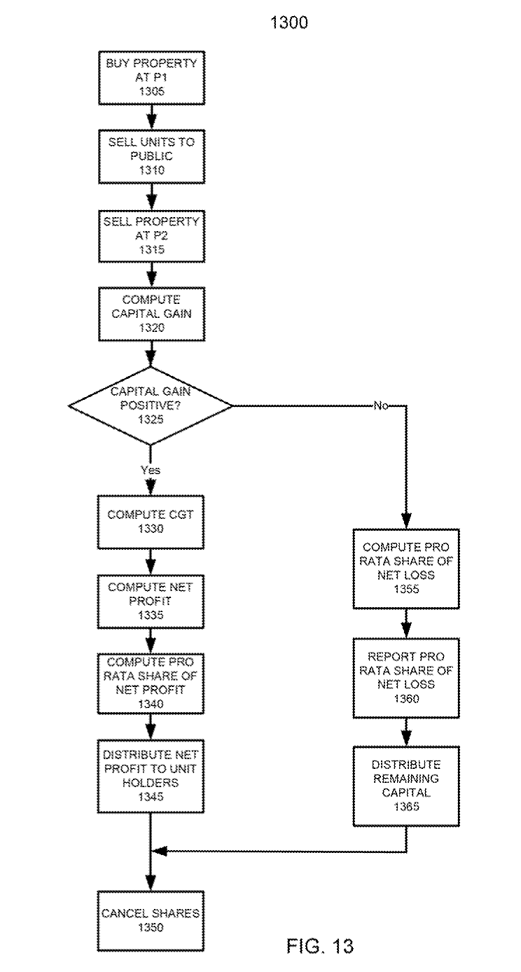

FIG. 13 is a process flow diagram illustrating selected steps and decision blocks of a process 1300 of selling the real property shares (or units) of which are publicly traded. The owner buys a property for a price P1 (step 1305). The owner sells shares of this property (i.e. of the business entity owning the property) to public (step 1310). The property is then sold to a buyer at a price P2 (step 1315). Some period of operation may be present between the steps 1310 and 1315, for example, in accordance with the description in relation to FIGS. 8 and 9. Capital gain or loss is then computed as the difference between the original purchase price P1 and sale price P2, possibly with a number of adjustments (step 1320). If the sale price P2 is greater than the purchase price P1, as determined in decision block 1325, capital gain tax (CGT) is computed (step 1330). A net profit is calculated by subtracting from the capital gain (CG) the capital gain tax and closing fees and disbursements (CE) in step 1335, as follows: NP=CG-CGT-CE. A pro rata share of the net profit is computed (step 1340) and distributed to the unit holders (step 1345), possibly together with the pro rata share of the original investment. The shares are then cancelled (step 1350). In the event the sale price P2 is less than the purchase price P1, as determined in the decision block 1325, net capital loss may result. In this event, pro rata share of the net loss is computed (step 1355) and reported to the unit owners and possibly also to taxing authorities (step 1360). Pro rata portion of the remaining capital is distributed to the unit owners in step 1365. The shares are then cancelled in the step 1350.

The shares (units) of publicly listed real property may be quoted together with one or more valuation metrics. One type of valuation metric is current value per unit, which may be computed by multiplying an estimate of the current value of the property by the pro rata portion of the property associated with the unit. When all shares/units have the same equity participation, for example, the current value per unit (CV/U) may be calculated using the following formula:

$$CV / U = \frac{CV}{N} ,$$

where CV is the estimated current value and N is the number of units outstanding. A price per value (p/v) ratio may obtained by dividing the current price per unit of real property into the current value per unit: p/v=CP/(CV/U).

The estimate of the current value may be obtained from a recent appraisal of the property. This approach depends on the availability of such appraisal. Periodic appraisals, however, increase operating costs. In accordance with another approach, the estimate of the current value is obtained by adjusting the latest appraised value (for example, the appraised value obtained when the real property was transferred to the business entity for listing on the exchange or at the time of the listing) by the percentage change in a real property value index since the latest appraisal. The index may be a cash-settled index. The index may be a nationwide real property index, a regional index, a statewide index, a citywide index, or index based on a different geographic constraint. The index may be specific to the kind of real property, for example, a single family residence index, duplex index, 1-4 unit index, apartment building index, office building index, farm property index, or another such index. The estimate of the current value may also (or instead) be adjusted by one or more additional factor's, such as the age of the building, the price range of the property (either absolute or as a percentile of all similar properties), construction type (e.g., brick, frame), number of rooms of a specific type bedrooms, bathrooms). In general, the current value estimate (CV) may be determined according to the following formula:

$$CV = AV \cdot {\prod }_{0}^{n} {AF}_{i} ,$$

where AV stands for the appraised valuation (at some time), and AFᵢ stands for nth adjustment factor, such as the cash-settled index or another factor discussed above.

In another embodiment, the current market value of the property is estimated based on comparative value readily available on the Internet from such companies as, for example, Zillow.com (http://www.zillow.com/). Thus, current market value can be estimated automatically in real time by entering the address of the property. This value, based on comparatives, may be used to compute market value per share. For example, a person interested in trading in shares of a particular real property would login online (through the Internet or an extranet) into the website of a real property exchange, select the desired property listing, and click on the indicator of market value per share for this property. A computer program operated by the real property exchange would automatically retrieve a current value by entering the address of the selected property on a website such as Zillow.com and retrieve the market value of the property calculated by the website. The computer program would then use the current market value to calculate the price per market value ratio and display through the website of the real property exchange.

In a particular example, on Date 1 a single family house was purchased and appraised for $1M. About the same time, the property was transferred to a corporation. The property is the sole substantial asset of the corporation. The corporation authorized and issued 100,000 shares with par value of $10.00. The occupant of the property paid $500,000 for 50,000 shares of the corporation. According to the controlling corporate documents, the occupant has, in addition to the 50,000 shares, a non-transferable right to occupy the property for a period of 10 years, and is obligated to maintain the property in good repair and to pay all taxes, assessments, casualty insurance, and similar expenses related to the property during the period of his or her occupancy. At the end of the 10 year period, the property is to be sold and proceeds distributed pro rata, unless the arrangement is extended and possibly modified for an additional period. Such extension and modification may be authorized by a majority (or two-third, three-quarter) vote of the shares other than those belonging to the occupant or another related party. Consent of the occupant would also be needed. In the meantime (i.e., during the original 10 year period), the shares are listed on a public exchange specializing in trading of similar real properties. The exchange provides bid/ask quotes for the shares. Additionally, the exchange or another entity provides one or more value metrics related to the stock. One such value metric is current value per share, as has been described above.

In another particular example, on Date 1 a single family house was purchased and appraised for $1M. The house has 3,000 sq. feet and is situated on one acre of property. At some later date, the property owner decides to sell half of her equity in the property in an initial public offering on a real property exchange. The owner obtains current appraisal of the house, which indicated the current market value of $1.1M. The owner also obtains current inspection report and a title report. The owner submits these reports along with the pictures of the house to an underwriting company (the underwriter), which evaluates the submitted information and agrees to underwrite the initial public offering of the shares of this real property on a real property exchange on a best effort basis. As per underwriter's suggestion, the property owner forms a corporation and authorizes 9,000,000 shares of common stock and 1,000,000 shares of blank check preferred stock, all shares having par value of $0.10 p/share. The property owner transfers her property to the corporation. The property owner issues one million shares of common stock (intended for the Initial Public Offering (IPO)) and one million shares of preferred stock to herself (and, possibly, to a spouse and/or children). The occupant and the owner of the property paid $500,000 for 1,000,000 shares of preferred stock of the corporation and $500,000 for 1,000,000 shares of common stock of the corporation. According to the controlling corporate documents, the owner of the 1,000,000 shares of preferred stock has a veto power and non-transferable right to occupy the property for a period of seven years, and is obligated to (a) pay monthly rent of $1,000.00 to the corporation and (b) maintain the property in good repair and to pay all taxes, assessments, casualty insurance, and similar expenses related to the property during the period of her occupancy. Rent may be used to pay the expenses. However, in the event such expenses exceed the funds in the corporation, it is the obligation of the occupant to lend money to the corporation or to borrow necessary funds from a bank. Subsequent rent payments may be used to repay such loan. At the end of the fiscal year, the occupant may issue the retained earnings as dividends to the owners of common stock. Preferred shareholder(s) may or may not be entitled to receive any dividends. In the event major repairs are reasonably anticipated in the following year, the property occupant may decide to issue only some of the retained earnings of the corporation as dividends, or not to issue any dividends at all. At the end of the seven year period, the property is to be sold and proceeds distributed pro rata, unless the arrangement is extended and possibly modified for an additional period. Such extension and modification may be authorized by a majority (or supermajority, such as two-third or three-quarter) vote of the shares of the common stock. Consent of the occupant who has the veto power as the owner of preferred stock would also be needed. The underwriter advises to price the IPO at $1.05 per share to offer prospective buyers a discount from the current market value. The underwriter agrees to sell 1,000,000 shares of common stock at $1.05 p/share on a best effort basis and signs a Letter of Intent to this effect. The underwriter creates an electronic Offering Memorandum (prospectus), publishes it on its website, and emails it to prospective investors. The underwriter assures that all regulatory agencies such as Securities and Exchange Commission and the State District Attorney approve the offering memorandum. The underwriter lists the shares to be sold in the IPO on a real property exchange or another exchange suitable for trading such shares. The property occupant retains a management company, which undertakes to collect rent from the occupant of the property on a monthly basis, to maintain the property and have it repaired as may be required, and to pay all taxes, insurance and other expenses associated with the property. This management company has the responsibility of issuing dividends to common stock shareholders with (or without) consent of the property occupant. The underwriter sells shares in the initial public offering and collects proceeds in an escrow account. If a predetermined minimum number of shares is sold, the offering is closed and the proceeds are distributed from the escrow account, first to pay off any outstanding mortgage on the property, and then to the property owner. In this example, the shares owned by the property owner are sold to the public and, therefore, the proceeds go to the owner rather than to the corporation as is typical in initial public offerings of corporate stock. In a variant, the property is sold to the corporation in exchange for a note. The proceeds of the IPO go to the corporation, which pays off the note, thereby providing the original property owner with the funds.

The exchange provides through its website electronic bid/ask quotes for the shares. Additionally, the exchange or another entity provides one or more value metrics related to the stock. One such value metric is current value per share, as has been described above.

Another value metric may be estimated current gross rent per share or unit. The estimated current gross rent per share may be estimated current gross rent divided by the number of shares outstanding:

$$CGRV / U = \frac{CGRV}{N} ,$$

where CGRV/U is the estimated current gross rent per unit, N is the number of units outstanding, and CGRV is estimated current gross rent for the entire property. Still another value metric may be estimated current net rent value per share or unit (CNRV/U), which is the estimated current gross rent less current property expenses (EXP, actual or estimated), divided by N, the number of units outstanding:

$$CNRV / U = \frac{( CGRV - EXP )}{N} .$$

The current gross rent may be estimated, for example, based on any one factor or any combination of factors on the following non-exhaustive list:

Square footage of the living area.

Number and types of rooms (e.g., bedrooms, bathrooms).

Number of garage spaces.

Age of the house.

Last rent for the property negotiated in an arm-length transaction. The last rent may be adjusted for the lapse of time by using a cash-settled rent index. For example, if the cash-settled index rose by 15 percent since the last rent was negotiated, the last rent may be adjusted upward by the same percentage. The cash-settled rent index may be a nationwide rent index, a regional rent index, a statewide rent index, a citywide rent index, or a rent index based on a different geographic constraint. The rent index may be specific to the kind of real property (e.g., single family residence, duplex, 1-4 unit, apartment building, office building, farm property).

Appraised market value rent. The appraised rent may be adjusted for the lapse of time since the appraisal based, for example, on the same indices listed under the immediately preceding bullet point.

Another value metric may be share price per are unit of area (ShP/UA), such as share price per square foot. This value metric can be obtained by dividing the current price per share into the number of square feet (or other area units) of real property in a share. For example, if one share is currently trading at $200 and corresponds to one square foot of property, than share price per square foot is $200 p/sq. f.

Another value metric may be average sale price per unit of area (ASP/UA), such as price per square foot. This ratio can be obtained by dividing recent sale prices of comparable properties in the same neighborhood into the number of square feet of sold properties. For example, if similar properties having combined area of 10,000 sq. ft. have been recently sold for the total of $1,000,000.00, the average sale price per sq, ft is $100.00.

Another value metric may be the ratio of share price per unit to average sale price per unit (ShP/ASP). For example, if the share price per square foot is $200 and the average sale price per square foot is S100.00, then the ratio is 2, which means that the share are traded at a premium of two times the average sale price per square foot.

In another embodiment according to the present invention, no corporation is used for the IPO. Instead, the real property owner contractually subdivides his or her real property in equal indivisible units or shares giving the owner of such unit or shares an indivisible fractional undivided non-possessory ownership of the real property. For example, if the real property has 3,000 sq. ft, it may be divided in units (or shares) of 1 sq. ft. each. In another example, such property may be divided into 1,000 equal parts (each part corresponding to one thousandth (0.1%) of the whole property. The ownership of such unit (share or part) would entitle its owner to receive a pro rata share of net income generated from rental or sale of the property. Such indivisible units of non-possessory undivided interest in a real property may be created contractually and offered for sale and traded on a specialized real property exchange. According to this embodiment, a contract subdividing the property into equal pans (shares or units) may also set forth the rights of the original property owner to occupy the property permanently or for a predetermined period of time (such as 10 years); the obligation of the property occupant to maintain the property in good repair and pay all relevant taxes, insurance and other expenses; payment of rent by the property occupant; distribution of rental income; sale of the property after a predetermined time period; the first refusal right to buy the property from the property occupant, and other terms, rights and obligations of the property occupant and the owners of shares (units) of fractional interest in the property. The rights and obligations under such contract would not be personal and would be transferable. A purchase of a fractional interest in a real property (expressed as a number of equal shares of this property) would, therefore, be equivalent to purchasing rights and obligations under such contract from one party to the contract by a third party. For example, a real property owner decides to sell a 50% interest in her real property to a plurality of investors, each of the investors buying a plurality of units, each unit corresponding to 1% interest in the property. If initially there were ten investors, each received five units. Essentially, this means that the original property owner signed a contract with the ten investors granting each of them a 5% indivisible interest in the property. The rights and obligations under this contract are personal to the property occupant, but are not personal to the investors. Furthermore, the investors' rights and obligations under the contract may be freely transferable. Selling a unit by one investor to another investor means, according to this embodiment, a transfer of a fractional indivisible interest in the property represented by one unit (in this example, 1%) from the seller of the unit to the buyer of the unit along with all other rights and obligations transferable under the contract.

It should be noted, however, that the sale of the real property within the specified period need not actually take place. At the expiration of such period, the property occupant who has the right of first refusal may have the option to have the property appraised and to distribute to holders of the units of real property their pro rata share of the fair market price.

While according to other embodiments wherein a property is incorporated (or transferred to a corporation, limited liability company or a limited partnership), which may provide for the shares of such corporation to be offered and traded on a stock exchange and may invoke oversight by the Securities and Exchange Commission, the embodiment described immediately above avoids incorporating the real property and instead contractually creates units of fractional indivisible interest in the property. This may allow trading of such units on a commodity exchange where commodity contracts are traded. Trading of such units may also be done on a specialized real property exchange created for this very purpose.

Continuing with the particular examples (in which a house is purchased on Date 1), the exchange on which the units are traded may be configured as the exchange 50 shown in FIG. 6. Setting up and operating the exchange may include the following steps:

establishing a secure network for operating the exchange;

establishing a first website for listing and trading the units of the business entity owning the real property and other similar units;

establishing a second website for hosting information about the units and/or the real properties;

establishing accounts for occupants of real properties (who may own substantial interests in the units of their respective properties);

establishing accounts for traders of the units in the real properties;

providing secure login to the occupants for logging into their respective accounts on the exchange and trading the units of the real properties;

providing secure logins to the traders for logging into their respective accounts on the exchange and for trading units of the real properties;

listing on the exchange units of the real properties;

maintaining a list of registered real estate agents licensed or authorized by the exchange;

maintaining a list of registered real estate brokers licensed or authorized by the exchange;

maintaining a list of registered real estate appraisers licensed or authorized by the exchange;

maintaining a list of registered real estate inspectors licensed or authorized by the exchange;

maintaining a list of property management companies licensed or authorized by the exchange;

operating electronic quotation system providing ask and bid quotes for real properties listed on the exchange; and

providing for trading of the units of real properties or shares of business entities owning such real properties.

The first website and the second website may be integrated into a single Internet portal.

The listings on the exchange may be limited to the listing of publicly-traded units/shares of a single investment real property occupied by an owner of at least a predetermined percentage of the outstanding units of the respective real property.

The information about the units and/or the real property may be hosted on one or more servers used to operate the exchange, such as the servers 51 of FIG. 6. The one or more servers may be connected to the secure network, such as the network 55. The hosted information may include one or more items on the following non-exhaustive list:

a picture of the real property (e.g., view(s) from the property, view(s) of the property from outside, view(s) of one or more rooms of the property or of the backyard/landscape of the property, or scenic view(s) from a window or porch of the property;

a 3-D virtual tour of the real property;

a guided tour of the real property (e. g., a video-recorded tour of the property with a real estate agent showing the property);

a survey of the real property;

information about title report and/or title insurance (e.g., title report and title insurance policy);

a zoom-able aerial view of the property (such as made available with Google Earth™);

a measurement or estimate of one or more areas of the real property (e.g., area of the land, square footage of various rooms);

floor plans of the real property;

information about inspection of the real property (e.g., an inspection report);

information about appraisal of the real property (e.g., an appraisal report);

information about units of the real property (e.g., a contract delisting units as indivisible units of non-possessory fractional interest in the real property, the rights of occupancy, obligation of the occupant to maintain the property, time and conditions of sale of the property, right of first refusal of the occupant to buy the property, and similar data);

information about trading of units of the real property (e.g., moving averages and other technical charts and analysis); and

information about real estate trends in the area of location of the real property.

The one or more servers may also host account information of the occupant of the real property and/or of the other traders authorized to trade on the exchange. The one or more servers may be loaded with software configured to match units offered for sale with offers to buy the units. The one or more servers may be connected to the Internet or an extranet for access by traders.

The units need not be limited to the real property. In some cases, for example, each unit may be a hybrid security, combining an equity interest with a share of the mortgage on the underlying real property. For example, an occupant may be able to refinance or finance the purchase of the real property through a combination of a hybrid security involving a combination of shares of the real property subject to a mortgage, and shares of a mortgage on the same property. For example, a home-owner may wish to borrow some money from the market to preserve his or her equity, and sell some equity to lower the debt service. Such hybrid security may pay interest and principal amortized over the life of the loan.

Another type of hybrid security that may be traded on a real property exchange is a unit containing shares of real property and one or more series of warrants to buy shares of the real property at a higher price. For example, a unit may comprise three shares of the real property at $100 p/share, two Series A warrants exercisable at $150 p/share, and one Series B warrant exercisable at $200 p/share. The warrants may be detachable and may be separately traded on an exchange.

The units may also be structured to guarantee a predetermined dividend payment, either fixed or variable. The dividend may be set as a function of the initial share price in the IPO and then current long-term interest rate. For example, the occupant may be obligated to pay a variable rent, in addition to the expenses, so as to guarantee the required dividend payment. The occupant may be given credit for the dividend properly distributable to the units owned by the occupant.

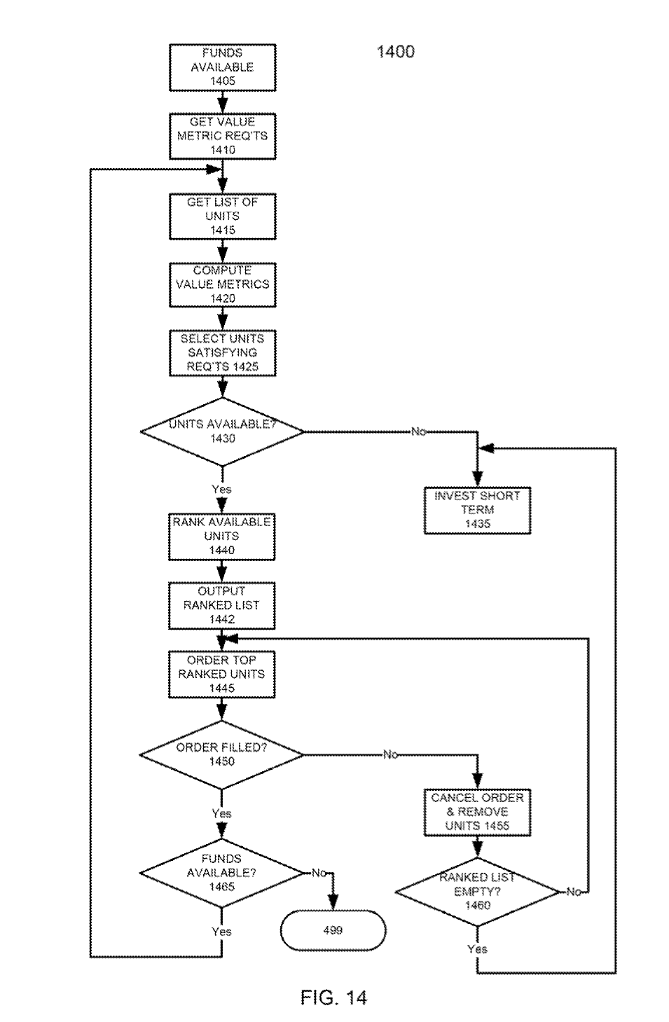

The units of various real properties may be screened in accordance with any one or any combination of value metrics. A mutual fund or exchange traded fund (ETF) may be created to own units of properties that meet predetermined conditions imposed on the value metrics. FIG. 14 is a process flow diagram illustrating selected steps and decision blocks of a process 1400 for operating a value fund specializing in units of occupied real properties, such as single family houses.

In step 1405, a computer system identifies availability of investable funds in the mutual fund or the ETF. The funds may be, for example, new fluids received from new or existing fund shareholders, or distributions received from owned properties (such as current income or proceeds from property sales). Investable funds may also result if the previous execution of the process 1400 did not result in a purchase of needed units for investment.

In step 1410, the computer system retrieves or otherwise obtains one or more value metric criteria, i.e., requirements that the purchased units must satisfy. The metrics may be retrieved, for example, from a local database or from a remote storage system over a network such as the Internet.

In step 1415, the computer system retrieves a list of all single family (or 1-4 family) real property units available for public trading, along with the current bid/ask prices and available volumes.

In step 1420, the system retrieves and/or computes the applicable value metric or metrics (such as CRV/U, CGRV/U, CNRV/U, ShP/UA, ASP/UA, ShP/ASP) based on the current asked prices. If the metrics are provided by the exchange where the units are traded, the system may retrieve them from the exchange. The system may also compute the value metrics autonomously, for example, by storing and/or retrieving from third sources the publicly available information regarding the underlying real property and the state and history of the real estate rents and values.

In step 1425, the system selects the units that satisfy the predetermined criteria. If such units are currently unavailable, as determined in decision block 1430, process flow proceeds to step 1435. In the step 1435, the available funds are invested in short term instruments, such as a money market fund, or left in such instruments until the next execution of the process 1400.

If one or more properties satisfy the criteria, process flow proceeds to step 1440 to rank the units in terms of their desirability based on the value metrics. For example, the units may be ranked in the order of decreasing CRV/U, CGRV/U, or CNRV/U, ShP/UA, ASP/UA, or ShP/ASP. A ranked list is obtained and, in step 1442, outputted (e.g., sent, displayed, and/or printed) to a person operating the fund.

In step 1445, the system places an order for a number of units (one or more) that ranked the highest on the list. The number may be limited by diversification criteria, or by the availability of the units in a thinly-traded market.

In decision block 1450, the system determines whether the order has been filled within a predetermined reasonable time interval. If the order has not been filled, it is cancelled and the units are removed from the ranked list, in step 1455. The process flow then continues to decision block 1460 to determine whether the ranked list is empty. If the list is empty, process flow jumps to the step 1435 to invest the funds in short term instruments. If the list is not empty, process flow returns to the step 1445 to place an order for the highest ranking units (which were second-highest ranking units prior to removal in the step 1455).

If the system determines in the decision block 1450 that the order has been filled, process flow proceeds to decision block 1465 to determine if funds for investment continue to be available. If investable funds are available, process flow returns, for example, to the step 1415. If funds are not available, the process terminates in flow point 1499.

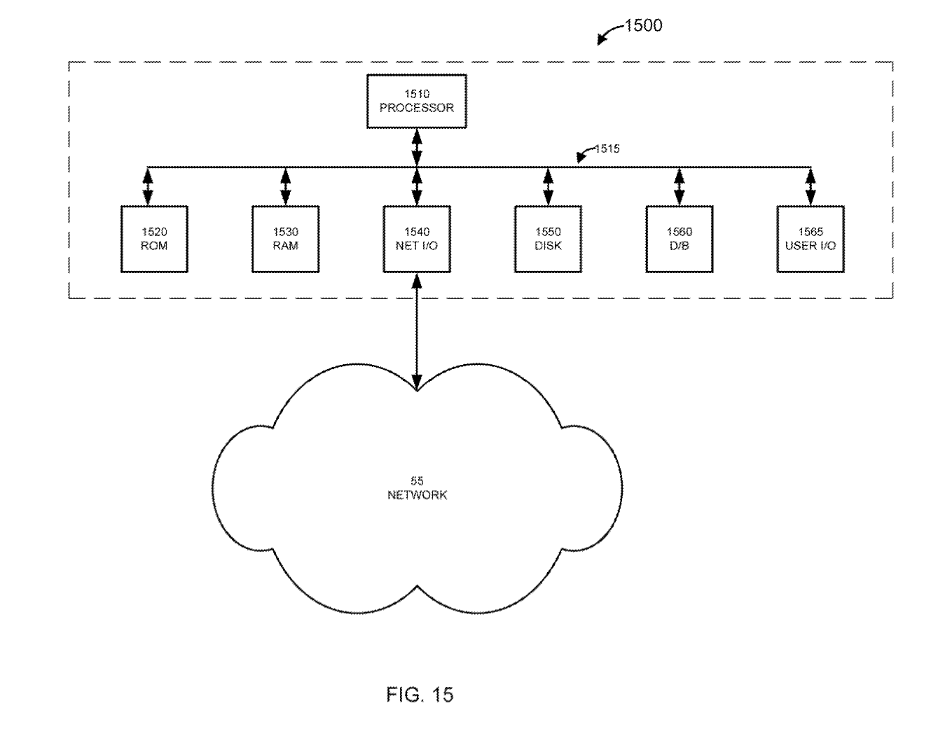

FIG. 15 is a simplified block diagram representation of a computer-based system 1500 configured in accordance with selected aspects of the present invention. The system 1500 may perform all or selected computations and/or computer-executable or computer-assisted steps described throughout this document. In particular, the system 1500 may be used to implement a specialized real property exchange and/or quotation system, or a system for running a fund. FIG. 15 does not show many hardware and software modules of the system 1500, and omits several physical and logical connections. The system 1500 may be implemented as a special purpose data processor, a mainframe, a minicomputer, a microcomputer, a group of parallel servers, a general-purpose computer, a computer system, or a group of networked computers or computer systems configured to perform the steps, decisions, and computations of the methods described. In particular, the system 1500 may be used to implement servers 51 and workstations 52. In some embodiments, the system 1500 is built on a personal computer platform, such as a Wintel PC or a Mac computer. The personal computer may be a desktop or a notebook computer.

The system 1500 includes a processor 1510, read only memory (ROM) module 1520, random access memory (RAM) module 1530, network interface 1540, a mass storage device 1550, a database 1560, and user I/O 1565. These components are coupled together by a bus 1515. In the illustrated embodiment, the processor 1510 is a microprocessor, and the mass storage device 1550 is a magnetic disk drive. The mass storage device 1550 and each of the memory modules 1520 and 1530 are connected to the processor 1510 to allow the processor 1510 to write data into and read data from these storage and memory devices. The network interface 1540 couples the processor 1510 to the network 55, for example, the Internet. The nature of the network 55 and of the devices that may be interposed between the system 1500 and the network 55 determine the kind of network interface 1540 used in the system 1500. In some embodiments, for example, the network interface 1540 is an Ethernet interface that connects the system 1500 to a local area network, which, in turn, connects to the Internet.

The database 1560 is used for organizing and storing data that may be needed or desired in performing the method steps described in this document. The database 1560 may be a physically separate system coupled to the processor 1510, as illustrated in FIG. 15. In one alternative embodiment, the processor 1510 and the mass storage device 1550 are configured to perform the functions of the database 1560. The database 1560 may be a hierarchical database or a relational database.

The processor 1510 reads and executes program code instructions stored in the ROM module 1520. Under control of the program code, the processor 1510 configures the system 1500 to perform the computations and/or computer-executable or computer-assisted steps described throughout this document. In addition to the ROM module 1520, the program code instructions may be embodied in machine-readable storage media, such as hard drives, floppy diskettes, CD-ROMs, DVDs, solid state memory, and similar devices. The program code can also be transmitted over a transmission medium, for example, over electrical wiring or cabling, through optical fiber (fiberoptic cable), wirelessly, or by any other form of physical transmission. The transmission can take place over a dedicated link between telecommunication devices, through a wide-area network (WAN) or local-area network (LAN), such as the Internet, an intranet, an extranet, or any other kind of public or private network. In one embodiment, the program code is downloaded to the system 1500 through the network interface 1540.

In another embodiment, indivisible units of non-possessory undivided fractional interest in a real property may be auctioned off. This may be implemented on an online auction, such as an Internet auction (e.g., similar to auctions conducted by eBay). In a variant, indivisible units of non-possessory undivided fractional interest in a real property are listed for auction on the Internet with a reserve price set by the seller, or without such reserve price. A “buy it now” price may also be indicated at which the seller is willing to terminate the auction and sell the listed units. A number of units available for sale may be indicated to allow a buyer to specify how many units the buyer wishes to by at “Buy it Now” price. The auction listing may include the property description, description of the units, description of the right of occupancy by the seller, description of the obligations of the occupant, and descriptions of similar items. In one example, a real property occupant who has subdivided his or her real property into indivisible units of non-possessory undivided fractional interest in a real property lists a number of such units (an auction lot) on an online auction (such as an eBay real estate auction). The seller of the units may set a reserve price and may also indicate a “Buy it Now” price (at which price the auction is ended). A winning bidder (if the bids reached or exceeded the Reserve Price when such reserve is set) pays the seller by stipulated means (e.g., PayPal, a credit card, or a money order). Upon receipt of funds the seller transfers the sold units to the winning bidder. This may, for example, be accomplished by transferring a real estate deed for the purchased undivided interest in the real property. The deed may state that the interest so deeded is a non-possessory interest. The deed may be a recordable deed or an unrecordable deed. The deed may be issued in the name of the buyer or in bearer's name.

In another variant, the owner of a real property sells shares in future appreciation of the property. In this variant, the real property is appraised at a current market value. A contract is prepared in which property appreciation is defined as all profits derived from future sale of the property in excess of the stipulated current market value and closing costs. The property appreciation so defined is divided in equal parts to create indivisible units of property appreciation. The contract may set forth the maximum time period within which the property must be sold. The contract may require the owner of the property to retain a minimum number of units of property appreciation, thereby encouraging the owner to maintain the property. The owner, for example, may be required to retain a minimum of 75%, 66%, 50%, 33%, 25%, or 10% of the units of property appreciation. The owner may further be given a first refusal right to purchase the property. Upon sale of the property within the stipulated time period, profits from the safe are distributed pro rata to the holders of the units of property appreciation. The contract may be issued in the name of the buyer of unit(s) of property appreciation or in the bearer's name.

It should be noted, however, that the sale of the real property within specified period need not actually take place. At the expiration of such period, the property occupant who has a first refusal right, instead of putting the property up for sale and then exercising his or her first refusal right and buying the property back from herself may choose to have the property appraised and distribute to holders of the units of property appreciation their pro rata share of the phantom or imputed profit, i.e., the difference between the current fair market price and the original price stipulated in the contract.

Consider, for example, the owner of a single-family house, currently appraised at $1,000,000, who needs to raise $100,000 without incurring more debt. The owner decides to sell 50% of the property appreciation to a group of ten real estate investors. The property owner prepares a contract which grants its holder a right to collect 1% percent of future property appreciation (defined as the difference between the future sale price of the property and the current market value of the property stipulated to be $1,000,000, less the costs of sale closing) upon the future sale of the property. The future sale must occur within ten years. In consideration for the appreciation right, an investor pays the property owner $2,000. Each of ten investors buys five such contracts, entitling each of them to collect 5% of future property appreciation in exchange for $10,000. The owner receives $100,000 and retains ownership of his or her property and the right of occupancy. In ten years, the owner sells the property for $2,000,000. The cost of closing is $5,000. The property appreciation is $1,000,000 less the cost of closing, netting $995,000 in appreciation. The escrow agent collects these funds and distributes the property appreciation to the contract holders. Each contract holder receives $49,750. The escrow agent distributes the remainder of the funds (assuming there was no mortgage on the property at the time of closing) in the amount of 497,500 to the owner of the property.

In the example immediately above, each contract for 1% of property appreciation represents one unit of property appreciation. These units may be listed and traded on an exchange adapted for trading such units. The exchange may allow for public trading.

Units of property appreciation from different properties may be packaged together as a pool for subsequent trading.

In some embodiments, the property owner may sell call options on the units of non-possessory undivided interest in real property. For example, the owner of a real property subdivides his or her property into equal indivisible units of non-possessory undivided interest in real property. In the context, a call option gives the purchaser of the option the right (but not the obligation) to purchase one unit of non-possessory undivided interest in real property at a set price (strike price). In some embodiments, the expiration of the call options may coincide with the expiration of the occupancy right, i.e., the contract creating the units of non-possessory undivided interest in real property stipulates that the property must be sold within a predetermined time period (e.g., 10 years) and this period expires on a certain date, called the Expiration Date (e.g., on Jul. 1, 2017). the call option granting the purchaser of the option the right to one unit of non-possessory undivided interest in real property will expire on the same Expiration Date (in this example, Jul. 1, 2017) regardless of when the call option is sold. The call options may grant the right to exercise on (for a European style option) or not later than (for an American style option) a future date, which may coincide with the Expiration Date for the underlying units (i.e., the latest date on which the property has to be sold). The buyer of the option pays a premium to the seller of the option, which may be influenced by such factors as current market value of the underlying real property in relation to the strike price, time to expiration, the risk-free interest rate, as well as the estimate of the future volatility of the real estate market in general and the underlying real property in particular.

In some embodiments, put options may be written in the anticipation of the decline in value of real estate in general or in a particular community. A put option on real property (or a unit thereof) grants the buyer of the put the right to sell the underlying property (or a unit thereof) to the seller at a predetermined price. The put options may be cash-settled based on an appraisal.

A real estate option contract may specify whether it is a call or a put option, the underlying real property (e.g., the property address and legal description), the strike (or the exercise) price, and the expiration date on which (European style option) or before which (American style option) the option is exercisable.

The options may be traded over-the-counter or on an exchange and cleared through Options Clearing Corporation (OCC) or other clearing house specifically adapted for clearing such options.

It should be noted that the seller (writer) of an option on real property (or a unit thereof) need not be the owner or the occupant of the property. In other words, the seller may be a holder of the option previously purchased, or a naked call writer.

A trader who believes that a property price will increase might buy the right to purchase the property or a fractional unit thereof (a call option). The buyer of the call option would have the right (but not the obligation) to buy the property (or a unit thereof) until the expiration date of the option. If the property's value increases over the exercise (strike) price by more than the premium paid, the buyer of the option could then profit. If the property value decreases, the buyer of the option may let the call option expire and only lose the amount of the premium. A trader might buy the option instead of the property (or fractional units thereof), because for the same amount of money, the buyer can obtain a larger number of options than units and properties. If the property value rises, the buyer will thus realize a larger gain than if he or she had purchased the property (or fractional units thereof), increasing the leverage.

A trader who believes that a property value will decrease in value can sell a call option on fractional units of non-possessory undivided interest in the real property (what is known as a “naked short call”). The trader selling a call has an obligation to sell the fractional units of the property to the call buyer at the buyer's option. If the price of fractional units of the property decreases, the short call position will make a profit in the amount of the premium. If the price of the fractional units of the property increases over the exercise price by more than the amount of the premium, the short call position will lose money.

A trader who sells a call option for those fractional units of property that he or she already owns sells a covered call. The seller of a covered call exchanges his upside risk (gains above the strike price) for the certainty of cash in hand (the premium). This strategy may be used by a property owner who subdivides his or her property into equal indivisible units of fractional non-possessory undivided interest in the property and sells some of these units. The property owner may sell covered calls on some of the units retained by him or her to raise more money and to hedge against possible decline in property value, in exchange for forgoing some of the upside potential.

A trader who believes that the property value will decrease can buy the right to sell the fractional units of non-possessory undivided interest in the property at a fixed price; this would be a long put position. The buyer of the put will be under no obligation to sell the fractional units, but has the right to do so until the expiration date of the put. If the price of fractional units decreases below the exercise price by more than the premium paid, the holder of the long put will profit. If the price of the units increases, the holder of the long put can just let the put contract expire and only lose the premium paid.

A trader who believes that the property value will increase can sell the right to sell the stock at a fixed price, thereby selling a naked put (or short put). The seller of the put now has the obligation to purchase the fractional units of non-possessory undivided interest in the property at a fixed price. If the price of the units increases, the short put position will make a profit in the amount of the premium. If the units' price decreases below the exercise price by more than the premium, the short position will lose money.

Various options strategies may be employed for trading real estate securities such as fractional units of non-possessory undivided interest in the property and their derivatives. These strategies may include covered calls (long the units, short a call), long straddle (long a call and long a put with the same exercise prices), short straddle (short a call and short a put with the same exercise prices), long strangle (long a call and long a put with different exercise prices), short strangle (short a call and short a put with different exercise prices), bull spread (long a call with a low exercise price and short a call with a higher exercise price, or long a put with a low exercise price and short a put with a higher exercise price), bear spread (short a call with a low exercise price and long a call with a higher exercise price, or short a put with a low exercise price and long a put with a higher exercise price), as wells as other options trading strategies well known to options traders, such as butterfly, condor, and box spread.

Methods of options pricing theory (e.g., Black Scholes model for European style option or Binomial options pricing model for American style option) may be used to help determine the pricing of units of property appreciation.

In some embodiments of the present invention, the property owner may wish to borrow from investors rather than from a bank in a form of mortgage. The disadvantage of borrowing money from a bank is that banks require pledging the house as collateral. Until the mortgage is paid off, the bank essentially owns the house. In fact, if the borrow defaults on the mortgage payments, the bank can foreclose and repossess the house. A more attractive option for a home-owner or an owner of commercial real estate may be to issue bonds. Such bonds may have yield which is higher or lower than prevailing mortgage rates. Such bonds may be sold to private investors or may be listed and traded on an exchange. Bonds issued by several real property owners may be packaged together in a pool. Bonds may also be packaged together with warrants to buy fractional shares of non-possessory undivided interest in the respective real property as a “sweetener” or to reduce the interest rate that need be offered in order to sell the bond issue.

Naked warrants to buy fractional shares of non-possessory undivided interest in real properties may be issued without an accompanying bond and traded on an exchange. These warrants may act as “covered” warrants and settle for cash without involving the property owner.

In other embodiments, various forms of derivatives may be used as financial instruments that are derived from the underlying value of real properties. Instead of buying and selling real properties, which involves substantial closing costs and real estate transfer taxes, not to mention the loss of occupancy, real estate market participants may choose to enter into an agreement to exchange money, assets, or some other value at some future date based on the underlying real property or properties. Real estate derivatives may be used for hedging or for speculation purposes. A real estate developer may wish to sell a future contract for the houses he plans to build in order to hedge against the risk of declining prices for homes in the neighborhood. A speculator may accept such a risk in anticipation of substantial profit and buy such futures contract. The builder knows with reduced uncertainty the profit the builder is making on the houses about to be built; the speculator will likely make a profit if the price rises, but also risks taking a loss if the price falls. Speculators may trade real estate derivatives with other speculators as well as with hedgers. Arbitrage opportunities may arise between different derivatives on identical or similar underlying real properties.

Investors who wish to speculate on direction of housing market could buy futures in housing prices. Speculators who believe the property values will rise could go long in such futures and profit if home prices increase. Those who believe the property values will fall could go short in such futures and profit if home prices will decline. Home owners intending to sell within a few years can hedge against decline in prices by going short in home price futures.

Real estate derivatives such as options and futures, as in other markets, may offer the greatest possible leverage in betting on whether the price of an underlying asset will go up or down. For example, a person may believe that real properties in certain community will go up in value by 20% in one year. If the person who has only one million dollars to invest bought a single property for $1,000,000, and its value rose to $1,200,000 in a year, the person would have made $200,000.00 profit, a 20% return. If the person borrowed money from a bank to buy the property (the maximum be could usually borrow would be 80% or half of the purchase price), he or she would have used only $200,000.00 dollars of his or her own money and thus made a 100% return. However, if the person paid a 10,000 dollar option premium to buy the property at $1,100,000, when the value of the property rose to $1,200,000 dollars he or she could have received the difference ($100,000) and thus make a 1,000% return.

In some embodiments, futures and options may be created around real estate indices such as, for example, the National Real Estate Index (NREI), FTSE EPRA/NAREIT Global Real Estate Index, S&P/GRA Commercial Real Estate Indices (SPCREX™), Case Shiller Home Price Indexes, Dow Jones Real Estate Index, Move-Up Home Index, Luxury Home Index, Elite Home Index, and Starter Home Index. Other real estate indexes may be created for specific types of properties and geographical areas. Writing (selling) and buying options tied to such real estate index may be done for hedging or speculative purposes. Such electronically-traded equity index futures contracts may be traded on an existing futures and options exchange or on the Internet-based exchange created for such purposes.

Real estate derivatives may be traded over-the-counter (OTC derivatives) or on an exchange (exchange-traded derivatives). A specialized real estate derivatives exchange may be created to facilitate trading real estate derivatives. Arbitrage-free prices for such derivatives may be determined by using Black-Scholes equation.

In some embodiments, a market is created for real estate mortgage swaps. Homeowners who pay monthly mortgage payments my find themselves in a situation when they deem an existing mortgage not optimal. For example, one homeowner who has obtained a fixed rate mortgage at the time of purchasing the house, now may wish he or she had a variable rate mortgage. Another person, who has opted for a variable rate mortgage, may now wish he or she had a fixed rate mortgage. While banks routinely offer refinancing options, they usually come at a cost. This cost may involve points and/or additional closing costs. The two homeowners may agree instead to swap their respective mortgages without involving the bank by agreeing to pay each other's mortgage. This would be an over-the-counter mortgage swap. An online exchange may be created to help homeowners identify potential partners for swaps. A small commission maybe charged by such online exchange for matching swap partners.

The process steps of the various methods described throughout this document are illustrated and/or explained serially. In specific non-limiting variants/embodiments, the process steps are implemented in the same order in which they are illustrated and/or explained. More generally, certain steps can be performed by separate elements in conjunction or in parallel, asynchronously or synchronously, in a pipelined manner, or otherwise. There is no particular requirement that the steps be performed in the same order in which this description lists them, except where explicitly so indicated or otherwise made clear from the context. Furthermore, not every illustrated step is required in every embodiment in accordance with the invention, while some steps that have not been specifically illustrated may be desirable or necessary in some embodiments in accordance with the invention. Each of the steps may encompass several sub-steps.

An exemplary description of a process step may appear in relation to one embodiment or Figure, but the same exemplary description also applies to similarly-named process steps in other embodiments and Figures.

This document describes in considerable detail the inventive apparatus, processes/methods, and articles of manufacture for creating, trading, and quoting publicly-traded securities and derivatives based on real properties, such as single family homes that are occupied by issuers of the securities; for creating, trading, and quoting indivisible units of non-possessory undivided interests in a real property, such as single family homes that are occupied by the original sellers of such units; and for creating and operating a specialize exchange for trading such units. This was done for illustration purposes only. Neither the specific embodiments of the invention as a whole, nor those of its features limit the general principles underlying the invention. In particular it should be noted that the securities are not necessarily limited to solely equity securities, but may also include debt components. The specific features described herein may be used in some embodiments, but not in others, without departure from the spirit and scope of the invention as set forth herein. Various physical arrangements of components and various step sequences also fall within the intended scope of the invention. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is carried out by the claims and their equivalents.

We claim:

1. A method of creating a publicly traded security, the method comprising:
forming a real property holding company with a plurality of partial interest units;
transferring ownership of a real property to the real property holding company; and
complying with applicable requirements for making the partial interest units publicly traded;
wherein at least one of the partial interest units belongs to an occupant of the real property.

2. The method of claim 1, further comprising conferring occupancy right to the occupant for at least an initial predetermined period.

3. The method of claim 2, further comprising requiring the occupant to pay current expenses of the real property during the initial predetermined period, the current expenses comprising casualty insurance, property taxes, and ordinary repairs and maintenance.

4. The method of claim 3, further comprising requiring the occupant to pay rent during the initial predetermined period.

5. The method of claim 4, further comprising adjusting the rent in accordance with variation in at least a cash-settled real estate index.

6. The method of claim 5, wherein the cash-settled index is computed based on rents payable for real estate.

7. The method of claim 5, wherein the cash-settled index is computed based on values of real estate.

8. The method of claim 5, wherein the cash-settled index is a nationwide index.

9. The method of claim 5, wherein the cash-settled index is a regional index.

10. The method of claim 5, wherein the cash-settled index is a state-wide index.

11. The method of claim 5, wherein the cash-settled index is a geographic index.

12. The method of claim 1, further comprising complying with applicable exchange-imposed requirements for listing the partial interest units on a public exchange.

13. A computer-based method of operating the exchange to trade the partial interest units created in accordance with claim 12, the method comprising:
listing the partial interest units on the exchange; and
providing for trading of the partial interest units on the exchange.

14. The method of claim 13, wherein the step of providing for trading comprises:
receiving buy and sell orders for the partial interest units; and
matching the buy and sell orders.

15. The method of claim 14, wherein the step of listing comprises providing quotation of prices of the partial interest units.

16. The method of claim 15, former comprising providing at least one value metric for the partial interest units.

17. The method of claim 16, wherein the step of providing at least one value metric comprises:
determining a first value estimate of the real property on a first date; and
adjusting the first value estimate in accordance with variation in a cash-settled real estate index between the first date and date on which the value metric is provided, thereby obtaining an adjusted value of the real property.

18. The method of claim 17, wherein the cash-settled index is computed based on nationwide values of real estate.

19. The method of claim 17, wherein the cash-settled index is computed based on regional values of real estate.

20. The method of claim 17, wherein the cash-settled index is computed based on state-wide values of real estate.

21. The method of claim 17, wherein the cash-settled index is computed based on values of real estate with the same number of residences as the real property.

22. The method of claim 17, further comprising dividing the adjusted value of the real property by number of the partial interest units outstanding, thereby obtaining adjusted value of the real property per unit.

23. The method of claim 22, wherein the step of providing at least one value metric further comprises transmitting the adjusted value of the real property per unit over a network.

24. The method of claim 22, wherein the step of providing at least one value metric further comprises displaying the adjusted value of the real property per unit.

25. The method of claim 1, wherein the step of forming the real property holding company is performed by the occupant.

26. The method of claim 1, wherein the real property is a primary residence of the occupant.

27. The method of claim 1, wherein the real property is a single family residence.

28. The method of claim 27, wherein:
the real property is sole investment asset of the real property holding company.

29. The method of claim 1, wherein the real property holding company is a corporation and wherein the units are shares of the corporation.

30. The method of claim 1, wherein the real property holding company is a limited partnership and wherein the units are equal limited partnership interests.

31. The method of claim 1, wherein the real property holding company is a limited liability company and wherein the units are equal membership interests of the limited liability company.

32. The method of claim 1, wherein the real property is a residential real property.

33. The method of claim 1, wherein the real property is a two-family house.

34. The method of claim 1, wherein the real property is selected from the group consisting of a two-family house, a three-family house, and a four-family house.

35. The method of claim 1, further comprising:
obtaining a title report for the real property;
obtaining an appraisal report for the real property; and
obtaining an inspection for the real property.

36. The method of claim 35, wherein the step of complying comprises:
preparing a registration statement for a public offering, said registration statement comprising information about the real property, the title report, the appraisal report, and the inspection report;
clearing the registration statement with applicable regulatory authorities; and
distributing the registration statement to a plurality of prospective investors.

37. A system comprising:
a network;
at least one server connected to the network;
a plurality of electronic devices connected by the network to interact with the at least one server;
a database storing information associated with publicly traded partial interest units in real properties, said database being implemented on said at least one server, said information comprising:
addresses of the real properties associated with the fractional interest units,
area information regarding the real properties, and
number of shares of fractional interest in real property holding companies owning the real properties; and
memory storing machine executable instructions for implementing a computerized quotation system for quoting prices of the fractional interest units, wherein the instructions, when executed by said at least one server, configure said at least one server to perform steps comprising:
quoting an ask price,
quoting a bid price,
accepting sell offers,
accepting buy offers,
matching at least one of said sell offers with at least one of said buy offers; and
executing a sale satisfying the at least one of said sell offers and the at least one of said buy offers.

38. The system of claim 37, wherein said network comprises an intranet or an extranet.

39. The system of claim 37, wherein said database is a relational database.

40. The system of claim 37, wherein said database is configured to be queried by said plurality of electronic devices.

41. The system of claim 37, wherein said database contains records with information about the properties, each record comprising:
geographic location of the real property associated with said each record;
purchase price and year of last purchase of the real property associated with said each record;
a general description of the real property associated with said each record; and
a picture of the real property associated with said each record.

42. The system of claim 41, wherein said each record further comprises information about appraisal of the real property associated with said each record.

43. The system of claim 41, wherein said each record further comprises information about title insurance on the real property associated with said each record.

44. The system of claim 41, wherein said each record further comprises information about historic trading prices for the fractional interest units of the real property holding company owning the real property associated with said each record.

45. The system of claim 37, wherein the bid and ask prices are quoted in real time.

46. A method of underwriting a public offering of units of a real property holding company, the method comprising:
selecting a real property;
performing a due diligence on said real property;
reviewing a title report;
reviewing an inspection report;
reviewing an appraisal report;
reviewing a registration statement;
setting an initial price for the units;
complying with requirements for public trading of the units;
executing an underwriting commitment agreement;
marketing said shares to prospective investors; and
charging a commission on sales of the units.

47. A method of transferring ownership of a real property owned by an owner to public through air initial public offering of shares, wherein said real property is encumbered by at least one mortgage, comprising the steps of:
setting up an escrow account;
collecting proceeds from sale of said shares of the real property from said initial public offering into said escrow account, wherein said proceeds are not less than said at least one mortgage;
repaying said at least one mortgage from said proceeds held in said escrow account; and
disbursing at least a portion of remaining funds in said escrow account to said owner of said real property.

48. A method of transferring fractional ownership in a privately-owned real property from an owner of the property to public, the method comprising:
forming a holding company;
assigning a title and interest in said real property to said holding company;
selling shares in said holding company to public;
paying rent to said holding company;
charging repairs and maintenance to said holding company; and
distributing profits as dividends to shareholders of said holding company.

49. The method of claim 48, wherein said holding company is selected from the group consisting of general partnership, limited liability partnership, limited liability company, corporation, and real estate investment trust.

50. A method of trading fractional ownership interests in a real property, the method comprising:
forming a corporation;
assigning said real property to said corporation as said corporation's only investment asset; and
listing said corporation on a stock exchange.

51. The method of claim 50, further comprising the step of trading shares of said corporation.

52. The method of claim 51, further comprising the step of trading derivative securities associated with said shares of said corporation.

53. A method of trading derivative securities associated with fractional ownership in a real property traded on a securities exchange, the method comprising the step of pricing said derivative securities based on price of underlying fractional ownership in said real property and time to expiration of said derivative securities.

54. The method of claim 53, wherein said derivative securities are futures.

55. The method of claim 53, wherein said derivative securities are options.

56. The method of claim 55, wherein said options are calls.

57. The method of claim 55, wherein said options are puts.

58. A method of selling interest in a real property, the method comprising the steps of:
selecting an appraiser from a predetermined set of appraisers;
securing an appraisal of said property by the selected appraiser;
selecting a property inspector from a predetermined set of property inspectors;
securing an inspection of said real property specifying at least one physical condition of said property by the selected property inspector;
dividing said real property into equal transferable fractional units of undivided non-possessory interest in said real property; and
selling said equal transferable fractional units of undivided non-possessory interest in said real property to a plurality of buyers.

59. The method of claim 58, wherein:
the step of selling said equal transferable fractional units of undivided non-possessory interest in said real property to a plurality of buyers is done through an exchange;
wherein said real property is listed on said exchange;
wherein said predetermined set of appraisers is comprised of appraisers authorized by said exchange; and
wherein said predetermined set of property inspectors is comprised of appraisers authorized by said exchange.

60. The method of claim 59, wherein said exchange is an online Internet-based exchange having a website, said website having a list of appraisers authorized by said exchange, a list of property inspectors authorized by said exchange, and a list of appraisers authorized by said exchange.

61. A method of publicly trading fractional interests in a real property, the method comprising:
dividing said real property into a plurality of equal units of fractional undivided non-possessory interest in said property;
issuing a plurality of shares, each share of said plurality of shares corresponding to one unit of fractional undivided non-possessory interest in said property, said each share entitling its owner to a corresponding unit of fractional undivided non-possessory interest in said property;
listing said shares on a public exchange adapted to trade fractional interests in real properties; and
selling said shares to a plurality of buyers on said exchange.

62. A method of operating a real property exchange for trading units of fractional undivided non-possessory interest in real properties, the method comprising the steps of:
maintaining a list of approved appraisers;
obtaining an appraisal by at least one of said approved appraisers in respect of each real property sought to be listed on said real property exchange;
creating a set of criteria for listing a real property on said real property exchange;
accepting for listing on said real property exchange a real property that meets said set of criteria; and
listing said units of fractional undivided non-possessory interest in said real property on said real property exchange, thereby making said units available for purchase by public.

63. The method of operating a real property exchange of claim 62, further comprising creating said list of approved appraisers.

64. The method of operating a real property exchange of claim 62 further comprising the step of requiring a property inspection.

65. The method of operating a real property exchange of claim 64, further comprising:
maintaining a list of approved property inspector's; and
requiring that said property inspection be performed by a property inspector selected from said list of approved property inspectors.

66. The method of operating a real property exchange of claim 65, further comprising creating said list of authorized property inspectors.

67. A combination comprising:
a real property;
a title insurance for said real property;
a homeowner's insurance for said real property;
an inspection report for said real property;
an appraisal of for said real property; and
a plurality of transferable shares corresponding to equal fractional units of undivided non-possessory interests in said real property for public trading of said shares on an exchange.

68. The combination of claim 67, further comprising said exchange for public trading of said shares.

69. The combination of claim 68, wherein said exchange comprises:
a network;
at least one server connected to said network;
a database for storing information associated with said real property, said database being implemented on said at least one server, said information comprising:
addresses of said real property,
area information regarding said real property, and
number of said transferable shares corresponding to equal fractional units of undivided non-possessory interests in said real property;
memory storing machine executable instructions for implementing a computerized quotation system for quoting prices of said transferable shares, wherein the instructions, when executed by said at least one server, configure said at least one server to perform steps comprising:
quoting an ask price,
quoting a bid price,
accepting sell offers,
accepting buy offers,
matching at least one of said sell offers with at least one of said buy offers, and
executing a sale satisfying the at least one of said sell offers and the at least one of said buy offers.

70. Financial instruments for trading fractional undivided non-possessory interests in real properties created by the process comprising the steps of:
selecting a real property;
subdividing said real property into a plurality of equal shares of fractional undivided non-possessory interest in said real property; and
issuing said shares for public trading on an exchange.

71. The financial instruments of claim 70, wherein said equal shares correspond to area units of said real property.

72. The financial instruments of claim 70, wherein said exchange is a stock exchange.

73. The financial instruments of claim 70, wherein said exchange is a commodity exchange.

74. The financial instruments of claim 70, wherein the process further comprises a step of issuing derivative securities based on said shares.

75. The financial instruments of claim 70, wherein said derivative securities are futures.

76. The financial instruments of claim 70, wherein said derivative securities are options.

77. A method of selling a real property, said real property being owned by a corporation having a plurality of shareholders, wherein the property was bought at a first price, wherein shares of said corporation are publicly traded, the method comprising the steps of:
selling said property to a second owner at a second price;
computing capital gain as the difference between the second price and the first price;
paying applicable capital gain tax on the sale of said property;
computing a net profit as the capital gain less said capital gain tax less legal fees and disbursements associated with closing of sale of said real property to the second owner;
computing a pro rata share of said net profit of the first owner of said property;
distributing the remaining net profits to said plurality of shareholders; and
cancelling the shares of said corporation.

78. The method of claim 77, further comprising:
setting an escrow account;
collecting money from the sale of said property into said escrow account; and
distributing pro rata shares of net profits to the first owner and to the shareholders from said escrow account.

79. The method of claim 78, wherein said shares are issued and registered by a transfer agent, wherein distributing pro rate shares and cancelling are performed by the transfer agent.

80. A computer-based method of operating an online real property exchange for trading shares of real properties comprising the steps of:
establishing a secure network for operating said exchange over said network;
establishing a first website for listing a plurality of fractional shares of undivided non-possessory interest in at least one real property;
establishing a second website for hosting information about said at least one real property;
establishing an account for the owner of said at least one real property;
establishing accounts for traders of said shares of said at least one real property;
providing secure login to said owner of said at least one real property for login into said account for the owner of said at least one real property;
providing secure logins to said traders for logging into said accounts for traders of said shares of said at least one real property;
listing the fractional shares of real property on said real property exchange; and
providing for trading of said shares in said at least one real property listed on said real property exchange.

81. A method of claim 80, wherein said first website and said second website are integrated into a single Internet portal.

82. A method of claim 80, wherein said information about said at least one real property includes:
a picture of said at least one real property;
an area of said at least one real property;
information about inspection of said at least one real property; and
information about an appraisal report of said at least one real property.

83. A system for operating a real property exchange for trading shares of real properties, the system comprising at least one server connected to a secure network for hosting:
information about at least one real property listed on said real property exchange said information further comprising information about an area of said at least one real property, information about inspection of said at least one real property, an appraisal report of said at least one real property and at least one picture of said at least one real property;
account information about the owner of said at least one real property listed on said real property exchange; and
account information about buyers and sellers of said shares of said at least one real property listed on said real property exchange;
said system further comprising a central processing unit, non-volatile storage and computer memory with loaded software program to match shares offered for sale by said sellers with offers to buy shares by said buyers.

84. A method of creating units of a real property owned by an occupant, the method comprising subdividing the real property into a plurality of indivisible units, wherein each of said units is an equal fractional share of non-possessory undivided interest in the real property.

85. A method of selling units of real property created according to claim 84, the method comprising:
listing said property on an exchange adapted to trade units of real property; and
selling at least one of said units on said exchange;
wherein the occupant of the real property owns one or more of said units.

86. A method of auctioning off units of real property created according to claim 84, the method comprising:
listing at least one of the units on an auction;
receiving funds from a highest bidder for the at least one of the units; and
transferring the at least one of the units to the highest bidder in response to the step of receiving funds;
wherein the occupant of the real property owns one or more of said units.

87. The method of claim 86, further comprising setting a reserve price for the at least one of the units.

88. The method of claim 86, further comprising setting a “Buy it Now” price for the at least one of the units.

89. The method of claim 86, wherein said auction is an online auction.

90. The method of claim 89, wherein said auction is an Internet-based auction.

91. A method of investing, comprising buying a unit created according to claim 84, wherein the occupant owns at least one of the units.

92. The method of claim 91, wherein said units are listed for public trading on an exchange.

93. A computer-based method of operating a real property exchange to trade the units created in accordance with claim 84, the method comprising:
listing the units on the real property exchange; and
providing for trading of the units on the real property exchange.

94. The method of claim 93, wherein the step of providing for trading comprises:
receiving buy and sell orders for the units; and
matching the buy and sell orders.

95. The method of claim 94, wherein the step of listing comprises providing quotation of prices of the units.

96. The method of claim 95, further comprising providing at least one value metric for the units.

97. The method of claim 96, wherein the step of providing at least one value metric comprises:
determining a first value estimate of the real property at a first date; and
adjusting the first value estimate in accordance with variation in a cash-settled real estate index between the first date and current date on which the value metric is provided, thereby obtaining an adjusted value of the real property.

98. The method of claim 97, wherein the cash-settled index is computed based on nationwide values of real estate.

99. The method of claim 97, wherein the cash-settled index is computed based on one of regional values of real estate, state-wide values of real estate, and values of real estate with the same number of residences as the real property.

100. The method of claim 93, wherein said real property exchange is an Internet-based exchange.

101. The method of claim 93, further comprising:
establishing listing criteria for listing real properties on said real property exchange;
verifying that applications for listing real properties on the real property exchange satisfy said listing criteria;
monitoring real properties listed on said real property exchange for compliance with said listing criteria; and
delisting from said real property exchange those real properties that no longer comply with said listing criteria.

102. The method of claim 97, further comprising dividing the adjusted value by number of the units created, thereby obtaining adjusted value of the real property per unit.

103. The method of claim 102, wherein the step of providing at least one value metric further comprises transmitting the adjusted value of the real property per unit over a network.

104. The method of claim 97, wherein the step of providing at least one value metric further comprises displaying the adjusted value of the real property per unit.

105. A method of creating units of real estate investment instrument for investment in a real property, the method comprising:
obtaining an appraisal of the real property to determine initial market value of said real property; and
offering for sale to at least one investor at least one unit of property appreciation in the real property from a plurality of units of property appreciation in the real property;
wherein:
property appreciation is a difference between (1) a future sale price of the real property, and (2) sum of the initial market value of the real properly as indicated by the appraisal and closing costs associated with the future sale;
the property appreciation is set to zero if the difference is negative; and
each of the units is obtained by dividing the property appreciation into equal parts.

106. The method of claim 105, further comprising setting a maximum time for the property appreciation to be distributed to the at least one investor, and making each of the units indivisible according to contract.

107. The method of claim 106, further comprising providing an occupant of the real property a right of first refusal to buy the property upon expiration of the maximum time for the property appreciation to be distributed to said at least one investor.

108. The method of claim 106, further comprising providing a seller of the units of property appreciation with an option to purchase back said at least one unit of property appreciation from said at least one investor within the maximum time, said future sale price being imputed in accordance with fair market value of the property at the time of the purchase back, the fair market value being determined by an appraisal.

109. The method of claim 105, further comprising listing said units of property appreciation on an auction.

110. The method of claim 109, wherein said auction is an online auction.

111. The method of claim 110, wherein said auction is an Internet-based auction.

112. The method of claim 111, wherein said auction is an eBay auction.

113. A method of investing in real estate, the method comprising buying one or more of the units of property appreciation created according to claim 105.

114. The method of claim 105, wherein the step of offering comprises:
listing the units of property appreciation on an exchange; and
providing for trading of said units of property appreciation on said exchange.

115. The method of claim 114, wherein the step of providing for trading comprises:
receiving buy and sell orders for the units of property appreciation; and
matching the buy and sell orders.

116. The method of claim 115, wherein the step of listing comprises providing quotation of prices of the units of property appreciation.

117. A method of creating a real-estate-backed derivative security, the method comprising the steps of:
selecting a real property;
obtaining an appraisal of said real property to determine the market value of said real property;
setting a strike price;
setting an expiration date;
complying with legal requirements for public trading of options on said real property; and
selling an option on said real property wherein an exercise price of the option is the strike price and an exercise date of the option is the expiration date.

118. The method of claim 117, wherein said real-estate-backed security is one of a call option and a put option.

119. The method of claim 117, wherein selling comprises auctioning off said option on an online auction.

120. The method of claim 117, wherein selling comprises listing said option on an exchange for public trading.

121. A method of creating real-estate options, the method comprising the steps of:
identifying a real property;
subdividing said real property into a number of equal units of fractional non-possessory undivided interest in said real property;
obtaining an appraisal of said real property to determine the market value of said real property;
setting a strike price;
setting an expiration date;
complying with legal requirements for public trading of options on said real property; and
selling an option on at least one of said units of fractional non-possessory undivided interest in said real property, wherein an exercise price of said option is the strike price and an exercise date of said option is on or before the expiration date.

122. The method of claim 121, wherein said real-estate option is one of a call option and a put option.

123. The method of claim 121, wherein selling comprises listing said option for auction on an online auction.

124. The method of claim 121, wherein selling comprises listing said option on an exchange for public trading.

125. The method of claim 121, wherein said units of fractional non-possessory undivided interest in said real property are traded on an exchange.

126. A method of direct public offering of a real property comprising the steps of:
selecting a real property occupied by an occupant;
forming a corporation, wherein said occupant is a president of the corporation;
transferring said real property to said corporation;
registering shares of said corporation under Small Corporate Offering Registration to obtain registered shares; and
offering the registered shares to investors;
wherein the amount of money raised from said investors through said offering does not exceed one million dollars in any one year.

127. A method of providing for public investing in real property holding companies, the method comprising:
setting criteria for initial listing on an exchange for public trading of a real property holding company, wherein the real property holding company has a plurality of fractional interest units, the real property holding company owns a real property occupied by an occupant, the occupant owns at least one of the fractional interest units, applicable legal requirements for public trading in the fractional interest units have been satisfied, and the real property is the sole investment asset of the real property holding company;
qualifying the fractional interest units for listing on the exchange based on the criteria;
listing the fractional interest units on the exchange;
providing for trading of the fractional interest units on the exchange;
monitoring compliance of the fractional interest units with criteria for continuing listing on the exchange; and
delisting the fractional interest units from the exchange in response to the fractional interest units failing to meet the criteria for continuing listing.

128. The method of claim 127, wherein the criteria for initial listing is identical to the criteria for continuing listing.

129. The method of claim 127, wherein the criteria for initial listing is different from the criteria for continuing listing.

130. The method of claim 127, further comprising operating a computer-based quotation system configured to quote ask and bid prices for the fractional interest units traded on the exchange.

131. The method of claim 130, wherein the computer-based quotation system comprises a network, and the exchange is configured for online trading over the network.

132. The method of claim 130, wherein the computer-based quotation system is further configured to provide at least one value metric of the fractional interest units, the at least value metric being computed by reference to a cash-settled real estate price index.

133. A method of facilitating trading, the method comprising:
listing units on an exchange:
providing for trading in the units on the exchange; and
making market in units by maintaining a bid and an ask price on the units;
wherein the units are fractional interest units of a real property holding company, the real property holding company owns a real property, the real property is the sole investment asset of the real property holding company, and applicable requirements for making the fractional interest units available for public trading have been complied with.

134. The method of claim 133, wherein the step of maintaining comprises:
buying at least one of the fractional interest units from a seller at a bid price; and
selling at least one of the fractional interest units to a buyer at an ask price;
thereby retaining a spread between bid and ask prices.

135. An apparatus comprising:
a local area network connected through a firewall to a wide area network;
at least one server connected to said local area network;
a portal for a plurality of electronic devices to connect through the wide area network to the at least one server;
a database for storing information associated with publicly traded shares of real properties, wherein said shares are equal indivisible transferable fractional units of non-possessory undivided interest in said real properties, the database being implemented on the at least one server, the information comprising addresses of the real properties associated with the shares of real properties, area data associated with the real properties, property type data associated with the real properties, market value data associated with the real properties, and number of said shares of real properties; and
memory storing machine executable instructions for implementing a computerized quotation system for quoting prices of the shares of real properties, wherein the instructions, when executed by the at least one server, configure the at least one server to perform steps comprising:
quoting an ask price;
quoting a bid price;
accepting sell offers:
accepting buy offers;
matching at least one of the sell offers with at least one of the buy offers; and
executing a sale satisfying the at least one of the sell offers and the at least one of the buy offers.

136. The apparatus of claim 135, wherein the information further comprises data about market value of the real properties.

137. The apparatus of claim 135, wherein the information further comprises data about appraisal and inspection of the real properties.

138. A method of transferring fractional ownership in a privately-owned real property from an owner of said real property to public, the method comprising:
forming a real estate holding company;
assigning title to and interest in said real property to said real estate holding company;
recording deed for said real property in the name of said real estate holding company;
listing said real estate holding company on an exchange;
offering shares in said real estate holding company for sale to public on said exchange; and
receiving money from sale of said shares in said real estate holding company.

139. The method of claim 138, wherein offering shares comprises making a Small Corporate Offering Registration (SCOR) offering.

140. The method of claim 138, wherein said real estate holding company is a real estate investment trust.

141. The method of claim 138, wherein said real estate holding company is a limited partnership, said owner of said property is a general partner, and the shares offered for sale on said exchange are shares of the limited partnership.

142. The method of claim 138, wherein said real estate holding company is a corporation.

143. The method of claim 138, wherein said real estate holding company is a limited liability company.

144. The method of claim 138, further comprising trading said shares of said real estate holding company.

145. The method of claim 144, further comprising trading derivative securities associated with said shares of said real estate holding company.

146. A method of assisting in a transfer of interest in a real property, the method comprising:
soliciting a person owning the real property to form a real property holding company with a plurality of partial interest units, transfer ownership of the real property to the real property holding company, comply with applicable requirements for making the partial interest units publicly traded, retain at least one of the partial interest units, and sell at least one of the remaining partial interest units to public; and
charging real estate brokerage commission to the person;
wherein formation documents of the real property holding company grant occupancy rights to the person.

147. The method of claim 146, further comprising:
arranging for an inspection report of the real property; and
arranging for an appraisal report of the real property.

148. The method of claim 146, further comprising:
submitting said inspection report to a public exchange; and
submitting said appraisal report to the public exchange.

149. The method of claim 146, further comprising:
arranging for a title insurance report of the real property; and
complying with applicable requirements for listing the fractional interest units on a public exchange, the step of complying comprising:
submitting said inspection report to said exchange,
submitting said appraisal report to said exchange, and
submitting said title insurance report to said exchange.
